(19) United States
(12) Patent Application Publication
(10) Pub. No.: US 2015/0069941 A1
(43) Pub. Date: Mar. 12, 2015

(54) Three-Phase Synchronous Motor Drive Device

(71) Applicants: Yoshitaka Iwaji, Tokyo (JP); Ryoichi Takahata, Tokyo (JP); Takahiro Suzuki, Tokyo (JP)

(72) Inventors: Yoshitaka Iwaji, Tokyo (JP); Ryoichi Takahata, Tokyo (JP); Takahiro Suzuki, Tokyo (JP)

(73) Assignee: Hitachi, Ltd., Chiyoda-ku, Tokyo (JP)

(21) Appl. No.: 14/391,625

(22) PCT Filed: Apr. 12, 2012
(86) PCT No.: PCT/JP2012/060040

§ 371 Date: Oct. 9, 2014

(51) Int. Cl. H02P 6/18

(52) U.S. Cl. CPC H02P 6/182; H02P 6/183
USPC 318/400.11; 318/400.34

(57) ABSTRACT

A three-phase synchronous motor drive device includes: a three-phase inverter 3 that drives a motor 4 that is as a three-phase synchronous motor, and that includes switching elements for three phases; a controller 2 that functions as a control unit that selects four switched states from a plurality of switched states that represent on/off states of the switching elements for the three phases, and that sequentially controls the three-phase inverter in the four switched states; a neutral point potential amplifier 13 that functions as a neutral point potential detection unit that detects a neutral point potential Vn0 of stator windings (Lu, Lv, Lw) of the motor 4 in each of the four switched states. It is configured that a rotor position of the three-phase synchronous motor is estimated over a full range of an electrical angle cycle based on at least three of four neutral point potentials detected in the four switched states.

### TECHNICAL FIELD

The present invention relates to a three-phase synchronous motor drive device, and also relates to an integrated type three-phase synchronous motor, to a position determination device, to a pump device and the like, all of which incorporate such a three-phase synchronous motor drive device.

### BACKGROUND ART

Permanent magnet electric motors (i.e. three-phase synchronous motors) are compact and have high efficiency, and such motors are widely used in various fields, such as industry equipment, consumer electronics, automobiles, and so on. However, for driving a permanent magnet motor, information about the position of the rotor of the motor is necessary, and due to this a position sensor has been required.

In recent years, it has become widely practiced to eliminate this position sensor, and it has become common to utilize sensor-less control for performing rotational speed control or torque control of a permanent magnet motor. By implementing sensor-less control, it is possible to economize upon the costs associated with the position sensor (i.e. the cost of the sensor itself, the cost entailed by the wiring for the sensor, and so on), and to make the entire system more compact. Moreover there are the merits that, by making the sensor unnecessary, it becomes possible to use the system in a poor quality environment, and so on. In current practice, for sensor-less control of a permanent magnet motor, either a method is employed of performing driving of the permanent magnet motor by directly detecting an induced voltage (i.e. a voltage due to speed) that is generated due to rotation of the rotor of the permanent magnet motor and by taking this as positional information for the rotor, or a technique of position estimation is employed in which an estimate of the rotor position is calculated from a numerical model of the subject motor, or the like.

However, there are also serious problems with these methods of sensor-less control. These problems occur with the position detection methods during low speed operation. The majority of methods of sensor-less control that are currently implemented in practice are ones based upon induced voltage generated by the permanent magnet motor. Accordingly, when the motor is stopped or in the low speed region in which the induced voltage is small, the sensitivity decreases undesirably, and there is a possibility that the position information may become buried in noise. Various strategies for solving this problem have been proposed.

With the invention described in Patent Document #1, position information is obtained by detecting the “neutral point potential”, i.e. the potential at the connection point of the stator windings for the three phases. By detecting this neutral point potential in synchrony with the pulse voltages supplied from the inverter to the motor, it is possible to detect voltage induced due to imbalance of the inductances, and it is possible to obtain the potential change depending upon the rotor position. Due to this, the above invention is distinguished by position information being obtained during normal sine wave modulation of the voltages supplied to the motor by PWM (pulse width modulation). Here, the rotor position means the position of the permanent magnet that is installed to the rotor.

### CITATION LIST

### Patent Literature

Patent Document #1: Japanese Laid-Open Patent Publication No. 2010-74898

### SUMMARY OF INVENTION

### Technical Problem

However, when an attempt is made to estimate the rotor position of a motor with the method described in the above Patent Document #1, it is only possible to perform position estimation over each half cycle (i.e. ±90°) of a full electrical angle cycle so that it is not possible to distinguish the magnetic polarity of the magnetic flux of the magnets. Accordingly, if the motor is started directly after the power supply to the inverter is turned on, there is a possibility that an error of 180° will be included in the position of the rotor that is estimated, and the motor may rotate in the opposite direction, at probability of ½.

### Solution to Problem

A three-phase synchronous motor drive device according to a first aspect of the present invention comprising: a three-phase inverter that drives a three-phase synchronous motor, and that comprises switching elements for three phases; a control unit that selects four switched states from a plurality of switched states that represent on/off states of the switching elements for the three phases, and that sequentially controls the three-phase inverter in the four switched states; a neutral point potential detection unit that detects a neutral point potential of stator windings of the three-phase synchronous motor in each of the four switched states; and a first rotor position estimation unit that estimates a rotor position of the three-phase synchronous motor over a full range of an electrical angle cycle based on at least three of four neutral point potentials detected in the four switched states; and wherein four switching vectors that indicate the four switched states comprises a first switching vector and a second switching vector that are mutually oppositely oriented, and a third switching vector and a fourth switching vector that are mutually oppositely oriented.

According to a second aspect of the present invention, in the three-phase synchronous motor drive device according to the first aspect, it is preferable that the control unit comprises a voltage command output unit that, during starting of rotation of the three-phase synchronous motor, outputs first three-phase voltage commands for initial position estimation that command the four switched states; and the first rotor position estimation unit estimates the rotor position during the starting of rotation based on the neutral point potentials detected when the first three-phase voltage commands are outputted from the voltage command output unit.

According to a third aspect of the present invention, in the three-phase synchronous motor drive device according to the second aspect, it is preferable that after output of the first three-phase voltage commands, the voltage command generation unit further outputs second three-phase voltage commands based on the rotor position estimated by the first rotor position estimation unit; and the second three-phase voltage commands are three-phase voltage commands indicating four switched states, such that the four switching vectors comprising two vectors on two sides of a rotor magnetic flux vector in a positive direction and two vectors on two sides of a rotor magnetic flux vector in a negative direction.

According to a fourth aspect of the present invention, in the three-phase synchronous motor drive device according to the second or third aspect, it is preferable to further comprise: a first voltage command correction unit that corrects voltage command for rotational torque generated by the control unit, so that third three-phase voltage commands generated based on phase current information for the three-phase synchronous motor become voltage commands that command the four switched states, and moreover become voltage commands that command, as the four switching vectors, vectors that are in a relationship of being close to a rotor magnetic flux vector; and wherein the control unit controls the three-phase inverter based on the voltage command for rotational torque that has been corrected by the first voltage command correction unit.

According to a fifth aspect of the present invention, in the three-phase synchronous motor drive device according to any one of the second to fourth aspects, it is preferable to further comprise: a second voltage command correction unit that corrects voltage command for rotational torque generated by the control unit, so that third three-phase voltage commands generated based on phase current information for the three-phase synchronous motor become voltage commands that command the four switched states, and moreover become voltage commands that command, as the four switching vectors, vectors that are in a relationship of being close to a vector that is orthogonal to a rotor magnetic flux vector; and wherein the control unit: controls the three-phase inverter based on the voltage command for rotational torque that has been corrected by the second voltage command correction unit, when magnitude of the voltage command for rotational torque is smaller than a predetermined value; and controls the three-phase inverter based on the voltage command for rotational torque that has been corrected by the first voltage command correction unit, when the magnitude of the voltage command for rotational torque is greater than or equal to the predetermined value.

According to a sixth aspect of the present invention, the three-phase synchronous motor drive device according to the fourth or fifth aspect may further comprise: a third voltage command correction unit that performs correction so that differences between voltage commands for respective phases in the third three-phase voltage commands become greater than a predetermined difference value.

According to a seventh aspect of the present invention, in the three-phase synchronous motor drive device according to any one of the fourth to sixth aspects, it is preferable to further comprise: a second rotor position estimation unit that estimates the rotor position of the three-phase synchronous motor based on two neutral point potentials among the four neutral point potentials, or based on an induced voltage induced in the stator windings; and a rotational speed determination unit that makes a determination as to whether or not a rotational speed of the three-phase synchronous motor is greater than a predetermined rotational speed, based on the rotor position estimated by the first or the second rotor position estimation unit; and wherein the control unit controls the three-phase inverter according to the four switched states when it is determined that the rotational speed is greater than the predetermined rotational speed, and controls the three-phase inverter according to two among the four switched states when it is determined by the rotational speed determination unit that the rotational speed is smaller than or equal to the predetermined rotational speed.

According to an eighth aspect of the present invention, in the three-phase synchronous motor drive device according to any one of the fourth to sixth aspects, it is preferable that the control unit controls the three-phase inverter according to the four switched states when a voltage outputted by the three-phase inverter is less than or equal to a predetermined value, and controls the three-phase inverter according to two among the four switched states when the voltage outputted by the three-phase inverter is greater than the predetermined value.

According to a ninth aspect of the present invention, in the three-phase synchronous motor drive device according to any one of the second to eighth aspects, it is preferable that the first rotor position estimation unit calculates a sum of the neutral point potentials detected for the first and second switching vectors and a sum of the neutral point potentials detected for the third and fourth switching vectors, and estimates the rotor position of the three-phase synchronous motor based on these two sums that have been calculated.

According to a tenth aspect of the present invention, in the three-phase synchronous motor drive device according to any one of the second to eighth aspects, it is preferable that the first rotor position estimation unit comprises: a first position information acquisition unit that obtains a difference between the neutral point potentials for two switching vectors, among the four switching vectors, that are oriented in a same direction, and that acquires first rotor position information based on this difference; a second position information acquisition unit that calculates a sum of the neutral point potentials detected for the first and second switching vectors and a sum of the neutral point potentials detected for the third and fourth switching vectors, and that acquires second rotor position information based on these two sums that have been calculated; and a polarity determination unit that determines magnetic flux polarity of the rotor position of the three-phase synchronous motor based on the first and second rotor position information; and wherein the rotor position of the three-phase synchronous motor is estimated based on a result of determination by the polarity determination unit and the first rotor position information.

According to an eleventh aspect of the present invention, in the three-phase synchronous motor drive device according to any one of the second to eighth aspects, it is preferable that the first rotor position estimation unit comprises: a first position information acquisition unit that obtains a difference between the neutral point potentials for two switching vectors, among the four switching vectors, that are oriented in a same direction, and that acquires first rotor position information based on this difference; and a polarity determination unit that acquires the neutral point potentials for one of the two switching vectors and for a switching vector that is oriented oppositely to the one switching vector, and that determines magnetic flux polarity of the rotor position of the three-phase synchronous motor based on a sum of those two neutral point potentials and the first rotor position information; and wherein the rotor position of the three-phase synchronous motor is estimated based on a result of determination by the polarity determination unit and the first rotor position information.

According to a twelfth aspect of the present invention, in the three-phase synchronous motor drive device according to any one of the second to eighth aspects, it is preferable that the first rotor position estimation unit comprises: a second position information acquisition unit that calculates a sum of the neutral point potentials detected for the first and second switching vectors and a sum of the neutral point potentials detected for the third and fourth switching vectors, and that acquires second rotor position information based on these two sums that have been calculated; a third position information acquisition unit that calculates a difference between the neutral point potentials detected for the first and second switching vectors and a difference between the neutral point potentials detected for the third and fourth switching vectors, and that acquires third rotor position information based on these two differences; and a polarity determination unit that determines magnetic flux polarity of the rotor position of the three-phase synchronous motor based on the second and third rotor position information; and wherein the rotor position of the three-phase synchronous motor is estimated, over the full range of the electrical angle cycle, based on a result of determination by the polarity determination unit and the third rotor position information.

An integrated type three-phase synchronous motor according to a thirteenth aspect of the present invention comprises, housed within a common casing, a three-phase synchronous motor drive device according to any one of the second to twelfth aspects, and a rotor and a stator of a three-phase synchronous motor that is driven and controlled by the three-phase synchronous motor drive device.

A position determination device according to a fourteenth aspect of the present invention comprises a three-phase synchronous motor drive device according to any one of the second to twelfth aspects; a three-phase synchronous motor that is driven and controlled by the three-phase synchronous motor drive device; and a position determination stage that is slidingly driven or rotationally driven by forward rotation and reverse rotation of the three-phase synchronous motor.

A pump device according to a fifteenth aspect of the present invention comprises: a three-phase synchronous motor drive device according to any one of the second to twelfth aspects; a three-phase synchronous motor that is driven and controlled by the three-phase synchronous motor drive device; and a pump for liquid, that is driven by the three-phase synchronous motor.

### Advantageous Effects of Invention

According to the present invention, it is possible to estimate the rotor position of a three-phase synchronous motor in the stopped state over the range of the full electrical angle cycle, and it is possible to implement sensor-less driving immediately from the stopped state with currents that are sine wave in form.

### BRIEF DESCRIPTION OF DRAWINGS

FIG. 1 is a figure for explanation of a first embodiment of a three-phase synchronous motor drive device according to the present invention;

FIG. 2 is a figure for explanation of voltage vectors (i.e. switching vectors);

FIG. 3 is a figure for explanation of neutral point potential;

FIG. 4 is a figure for explanation of the relationship between the voltage vectors and the neutral point potentials;

FIG. 5 is a figure showing changes of the neutral point potentials VnA, VnB, VnC, VnD, VnE, and VnF with respect to rotor position θd (i.e. phase);

FIG. 6 is a figure showing changes of the neutral point potentials VnA, −VnB, VnC, −VnD, VnE, and −VnF;

FIG. 7 is a figure showing the result θdc when rotor position estimation has been performed using neutral point potentials detected in relation to two voltage vectors;

FIG. 8 is a figure showing three-phase voltage commands Vu0*, Vv0*, and Vw0*, PWM pulses, voltage vectors, and the neutral point potential Vn0 in the first embodiment;

FIG. 9 is a block diagram of an initial position estimator 19;

FIG. 10 is a figure showing waveforms of VnA, VnB, VnD, VnE, VnU, and VnW, and an estimated phase angle θds;

FIG. 11 is a block diagram of an initial position estimator 19B of a second embodiment;

FIG. 12 is a figure showing, for the initial position estimator 19B, the waveforms of VnA, VnB, Xα, and Xβ, and estimated phase angle θds0;

FIG. 13 is a block diagram of an initial position estimator 19C of a third embodiment;

FIG. 14 is a block diagram of an initial position estimator 19D of a fourth embodiment;

FIG. 15 is a figure showing Xα, Xβ, and θds0 in the fourth embodiment;

FIG. 16 is a block diagram of a controller 2E of a fifth embodiment;

FIG. 17 is a figure showing the structure of a voltage command generator 17E for initial position estimation;

FIG. 18 is a vector diagram showing the relationship between four voltage vectors and rotor position;

FIG. 19 is a block diagram of a controller 2F of a sixth embodiment;

FIG. 20 is a figure showing the structure of a Vq corrector 21;

FIG. 21 is a figure showing the waveform of a signal dVq;

FIG. 22 is a figure showing an applied voltage vector when Vq** is used;

FIG. 23 is a figure showing a PWM pulse waveform before correction by a three phase corrector 22;

FIG. 24 is a figure showing a PWM pulse waveform after correction by the three phase corrector 22;

FIG. 25 is a block diagram of a Vq corrector 21G of a seventh embodiment;

FIG. 26 is a figure for explanation of selection of a voltage vector when a voltage command Vq* is “+”;

FIG. 27 is a figure for explanation of selection of a voltage vector when a voltage command Vq* is “−”;

FIG. 28 is a figure showing the structure of a controller 2H of an eighth embodiment;

FIG. 29 is a figure showing an integrated type three-phase synchronous motor according to a ninth embodiment;

FIG. 30 is a figure showing a pump device 300 according to a tenth embodiment;

FIG. 31 is a figure showing the structure when a relief valve has been eliminated from the pump device 300 shown in FIG. 30;

FIG. 32 is a figure showing a compressor drive system according to an eleventh embodiment;

FIG. 33 is a figure showing the overall block structure of a position determination device according to a twelfth embodiment;

FIG. 34 is a figure for conventional PWM control, showing PWM waveforms, a neutral point potential waveform, and so on; and

FIG. 35 is a block diagram showing a Vq corrector 21H of the eighth embodiment.

### DESCRIPTION OF EMBODIMENTS

In the following, embodiments of the present invention will be explained with reference to the figures. It should be understood that a three-phase synchronous motor drive device according to the present invention may be applied to rotational speed control of a fan, a pump (a hydraulic pump or a water pump), a compressor, a washing machine, a spindle motor, a disk drive or the like, to a position determination device for a conveyor or a machine tool, or to an application that controls torque, such as electrical power assistance system or the like.

### First Embodiment

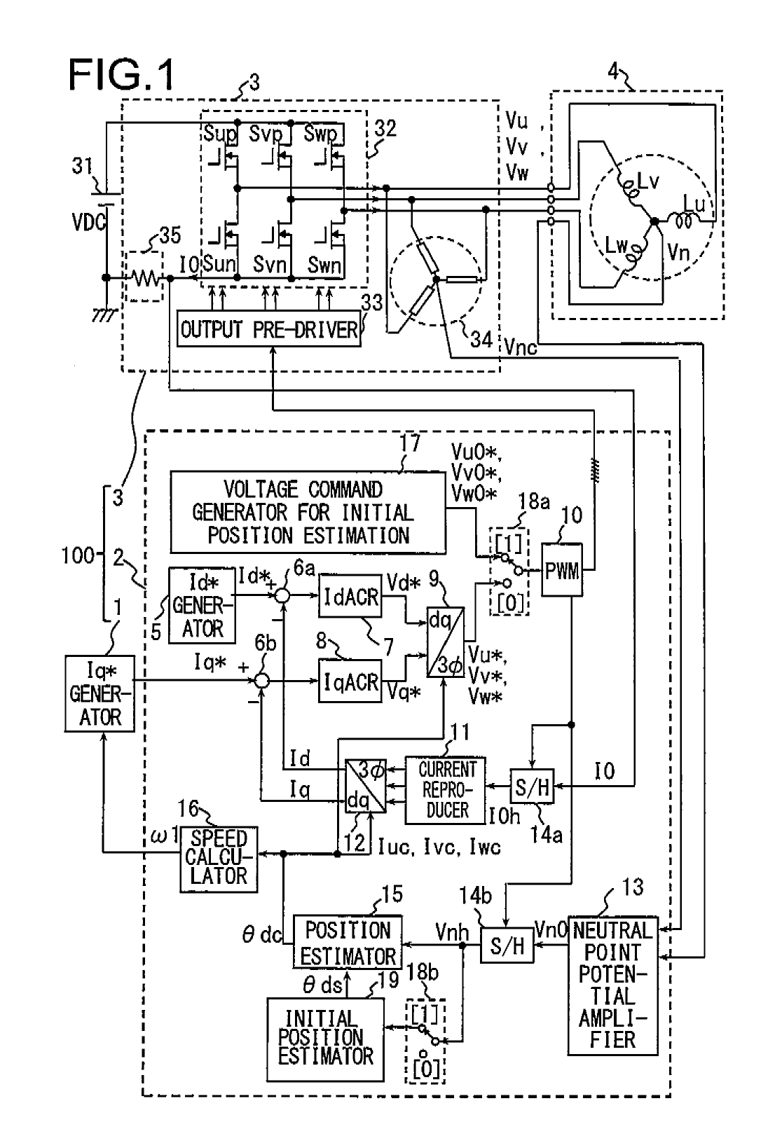

FIG. 1 is a figure for explanation of a first embodiment of the three-phase synchronous motor drive device according to the present invention. A drive control device 100 is a device that drives a permanent magnet motor 4 (hereinafter referred to as the “motor”) that is a three-phase synchronous motor, and that comprises an Iq* generator 1, a controller 2, and an inverter 3 that includes a main inverter circuit 32 and a one-shunt current detector 35. The inverter 3 is connected to a DC power supply 31.

The Iq* generator 1 is a circuit that generates a current command Iq* corresponding to the torque of the motor 4. This Iq* generator 1 is a controller at a higher level than the controller 2. While in this construction the Iq* generator 1 is included within the drive control device 100, it would also be acceptable, in another construction, for it not to be so included. Normally, it is arranged to generate the current command Iq* that is required for the rotational speed of the motor 4 to become a predetermined speed, while observing the actual speed ω1. This current command Iq* that is the output of the Iq* generator 1 is outputted to a subtractor 6b provided in the controller 2.

The controller 2 operates so that the motor 4 generates a torque corresponding to the current command Iq*. This controller 2 comprises an Id* generator 5 (i.e. a d axis current command generator), a subtractor 6a, the subtractor 6b, a d axis current controller 7 (i.e. an IdACR), a q axis current controller 8 (i.e. an IqACR), a d-q inverse converter 9, a PWM generator 10, a current reproducer 11, a d-q converter 12, a neutral point potential amplifier 13, sample/hold circuits 14a and 14b, a position estimator 15, a speed calculator 16, a voltage command generator 17 for initial position estimation, initial position estimation changeover switches 18a and 18b, and an initial position estimator 19.

Apart from comprising the above described main inverter circuit 32 and one-shunt current detector 35, the inverter 3 also comprises an output pre-driver 33 and a virtual neutral point circuit 34. The DC power supply 31 is a DC power supply that supplies power to the inverter 3. The main inverter circuit 32 is an inverter circuit that comprises six switching elements Sup through Swn. MOSFETs or IGBTs or the like maybe used for the switching elements Sup through Swn. The output pre-driver 33 is a driver that drives the main inverter circuit 32 directly. The virtual neutral point circuit 34 is a circuit that generates a virtual neutral point potential with respect to the output voltages of the main inverter circuit 32. And the one-shunt current detector 35 is a current detector that detects the supply current I0 to the main inverter circuit 32.

The Id* generator 5 of the controller 2 generates a current command Id* for the d axis current that corresponds to the excitation current of the motor 4. The subtractor 6a subtracts the output Id of the d-q converter 12 from the current command Id* outputted by the Id* generator 5, and obtains the deviation of the output Id with respect to the current command Id*. And the subtractor 6b subtracts the output Iq of the d-q converter 12 from the current command Iq* outputted by the Iq* generator 1, and obtains the deviation of the output Iq with respect to the current command Iq*. It should be understood that the outputs Id and Iq of the d-q converter 12 are derived and reproduced on the basis of the output of the main inverter circuit 32.

The d axis current controller (i.e. the IdACR) 7 calculates a voltage command Vd* on the d-q coordinate axes so that the current deviation of the subtractor 6a becomes zero. On the other hand, the q axis current controller (i.e. the IqACR) 8 calculates a voltage command Vq* on the d-q coordinate axes so that the current deviation of the subtractor 6b becomes zero. The voltage command Vd* calculated by the d axis current controller 7 and the voltage command Vq* calculated by the q axis current controller 8 are inputted to the d-q inverse converter 9.

The d-q inverse converter 9 is a circuit that converts the voltage commands Vd* and Vq* in the d-q coordinate system (magnetic flux axis-axis orthogonal to the magnetic flux axis) to three-phase AC coordinates. On the basis of the output θdc of the position estimator 15, the d-q inverse converter 9 converts the voltage commands Vd* and Vq* that are inputted into three-phase AC voltage commands Vu*, Vv*, and Vw* that are control signals in the three-phase AC coordinate system. These three-phase AC voltage commands Vu*, Vv*, and Vw* after conversion are inputted to the PWM generator 10 via the initial position estimation changeover switch 18a.

The PWM generator 10 outputs PWM (Pulse Width Modulation) signals based on which switching operation of the main inverter circuit 32 is executed. PVu, PVv, and PVw, which are PWM waveforms, are generated by the PWM generator 10 on the basis of the three-phase AC voltage commands Vu*, Vv*, and Vw*. Moreover, these outputs PVu, PVv, and PVw are inputted to the output pre-driver 33, to the sample/hold circuit 14a, and to the sample/hold circuit 14b.

The neutral point potential amplifier 13 is a circuit that detects and amplifies the difference between the three phase winding connection point potential Vn of the motor 4 and the virtual neutral point potential Vnc that is the output of the virtual neutral point circuit 34 (hereinafter this difference will be termed the neutral point potential Vn0). The result of amplification by this neutral point potential amplifier 13 is inputted to the sample/hold circuit 14b.

The sample/hold circuit 14a is an A/D converter for sampling and quantizing the detection signal from the one-shunt current detector 35. The sample/hold circuit 14a samples this detection signal (here, this signal is called “10”) in synchrony with the PWM pulses that are the output of the PWM generator 10.

The current reproducer 11 is a circuit that receives the I0 signal that has been inputted via the sample/hold circuit 14a, and reproduces the currents of the U phase, the V phase, and the W phase. These currents for the various phases that have been reproduced (Iuc, Ivc, and Iwc) are outputted to the d-q converter 12.

The d-q converter 12 converts Iuc, Ivc, and Iwc, which are the reproduced values of the phase currents of the motor, to Id and Iq in d-q coordinates, which are rotation coordinate axes. This Id and Iq resulting from the conversion are used in the calculation of the deviations of the current command Id* and the current command Iq* by the subtractors 6a and 6b described above.

On the other hand, the sample/hold circuit 14b is an A/D converter for sampling and quantizing the analog signal output of the neutral point potential amplifier 13 (i.e. the neutral point potential Vn0). This sample/hold circuit 14b samples the neutral point potential Vn0 in synchrony with the PWM pulses that are the output of the PWM generator 10. The sample/hold circuit 14b outputs the result (Vnh) obtained by this sampling as a digital signal to the position estimator 15 and the initial position estimation changeover switch 18a.

The position estimator 15 calculates an estimated value θdc of the rotor position (i.e. the phase angle) θd of the motor 4 on the basis of the output Vnh of the sample/hold circuit 14b. As described above, the rotor position means the position of the permanent magnet that is installed to the rotor. The result of this estimation is outputted to the speed calculator 16, to the d-q converter 12, and to the d-q inverse converter 9.

The speed calculator 16 calculates the rotational speed of the motor 4 from the estimated value θdc of the rotor position. This rotational speed ω1 that has thus been estimated is outputted to the Iq* generator 1, and is made use of in current control for the axis (i.e. the q axis) that is orthogonal to the magnetic flux axis (i.e. to the d axis).

Next, the motor drive control will be explained. Fundamentally, the motor drive control with the drive control device 100 of this embodiment is per se known as a vector control technique for linearizing the torque of a synchronous motor, i.e. of an AC motor. In theory, this vector control technique is a technique in which, in rotation coordinate axes that take the rotor position of the motor as a reference (i.e. d-q coordinate axes), the current Iq that contributes to the torque, and the current Id that contributes to the magnetic flux, are controlled independently. The d axis current controller 7, the q axis current controller 8, the d-q inverse converter 9, and the d-q converter 12 and so on in FIG. 1 are the main sections for implementation of this vector control technique.

In the drive control device 100 of FIG. 1, a current command Iq* that corresponds to the torque current is calculated by the Iq* generator 1, and current control is performed so that this current command Iq* and the actual torque current Iq of the motor 4 agree with one another. In the case of a permanent magnet motor of the non-salient-pole type, normally “zero” is supplied as the current command Id*. On the other hand, in the case of a permanent magnet motor of salient pole construction, or during control in which the field magnetism is weak, in some cases, a negative command value is supplied as the current command Id*.

It should be understood that in current detection for the motor 4, although it is desirable to detect the phase currents supplied from the inverter 3 to the motor 4 directly, in many cases, in detection of the currents of a compact permanent magnet motor, a technique is adopted of detecting the DC current, and reproducing the phase currents internally to the controller 2. The technique of calculating and reproducing the phase currents from the DC current I0 at this time is a per se known technique, and description thereof will be omitted, since it is not a crucial portion of the present invention.

### (The Voltage Vectors)

The output voltages of the various phases of the inverter 3 are determined by the ON/OFF states of the upper side switching elements (Sup, Svp, Swp) and of the lower side switching elements (Sun, Svn, Swn) of the main inverter circuit 32. For each of the phases, it is necessary for one of the corresponding upper side switching element and the corresponding lower side switching element to be in the ON state, and for the other thereof to be in the OFF state. Accordingly the output voltages of the inverter 3 can assume any one of a total of eight switched patterns.

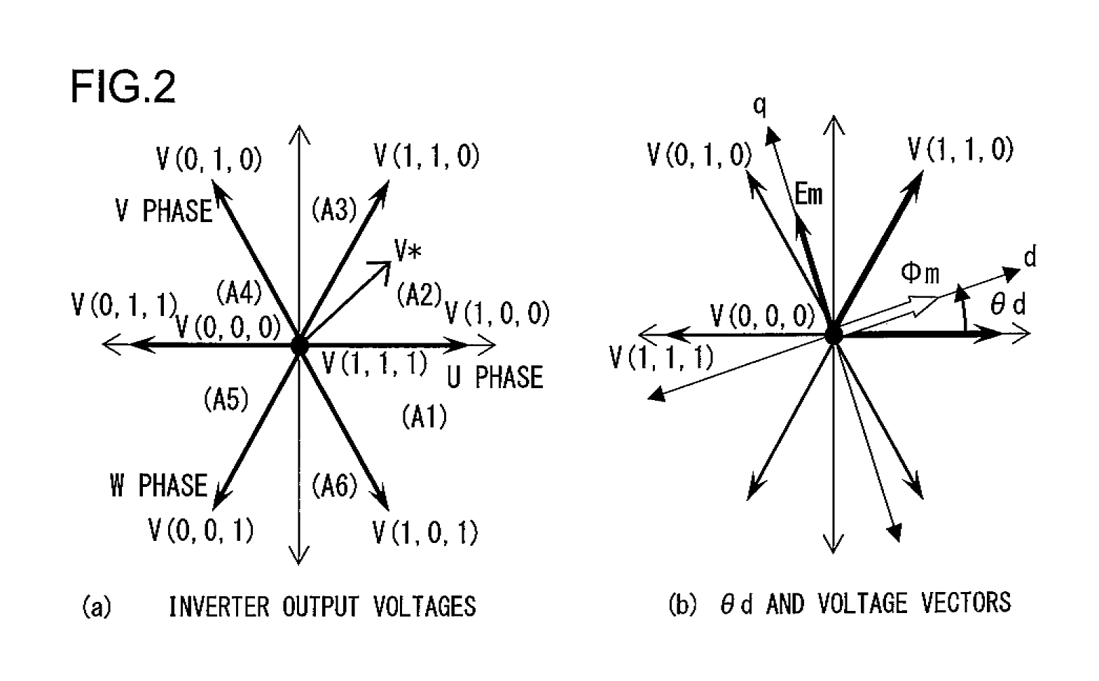

FIG. 2 is a vector diagram in which the switched states are expressed as vectors with respect to stator coordinate axes upon the stator: FIG. 2(a) shows the switched states of the inverter output voltages, while FIG. 2(b) shows the relationship between the rotor position (i.e. the phase) θd and the voltage vectors (also termed the switching vectors). These voltage vectors are expressed in notation such as “V(1,0,0)”. In this vector notation, the numerals within the parentheses specify the switched states of the U phase, the V phase, and the W phase in that order, with the ON state of the upper side switch being specified by “1” and the ON state of the lower side switch being specified by “0”.

The inverter output voltages can be expressed as eight vectors (i.e. voltage vectors) that include two zero vectors. These voltage vectors may be expressed upon two axes as shown in FIG. 2 by performing α-β coordinate conversion upon the switched states of the three phases. Moreover, in a similar manner, the voltages supplied to the motor can also be expressed as vectors upon two axes (the vector V* shown in FIG. 2(a) is a voltage command expressed as a vector).

While it is possible for the voltage command V* to assume any desired value, there are only eight voltages that can be outputted by the inverter 3, as shown in FIG. 2 (among these, two are zero vectors). Due to this, the PWM voltages that correspond to the voltage command are supplied to the motor 4 by combining these eight voltage vectors.

In concrete terms, in each of the regions (A1) through (A6) shown in FIG. 2(a) (these will be termed “modes” 1 through 6), a voltage corresponding to the voltage command V* is outputted by using the vectors that are positioned at the vertex of that triangular region (the zero vectors V(0,0,0) and V(1,1,1) and the two vectors at the two sides of that region). In the case shown in FIG. 2(a), since the voltage command V* is present in the region (A2) of mode 2, accordingly the two zero vectors V(0,0,0) and V(1,1,1) and the two voltage vectors V(1,0,0) and V(1,1,0) at the two sides of that region (A2) are employed.

Moreover, when the relationship with the rotor position of the motor is displayed, it appears as shown in FIG. 2(b). The rotor position θd (i.e. the phase) is defined as shown in FIG. 2(b), by taking the reference for the rotor position of the motor 4 as being the U phase axis. The d axis direction of the d-q coordinate axes, which are rotation coordinates, agrees with the direction Φm of the magnetic flux m of the permanent magnets, and rotates in the anticlockwise direction. In the vicinity of θd=0 (deg), the induced voltage Em is in the q axis direction shown in FIG. 2(b). With these conditions, the motor is principally driven by using the voltage vectors V(1,1,0) and V(0,1,0).

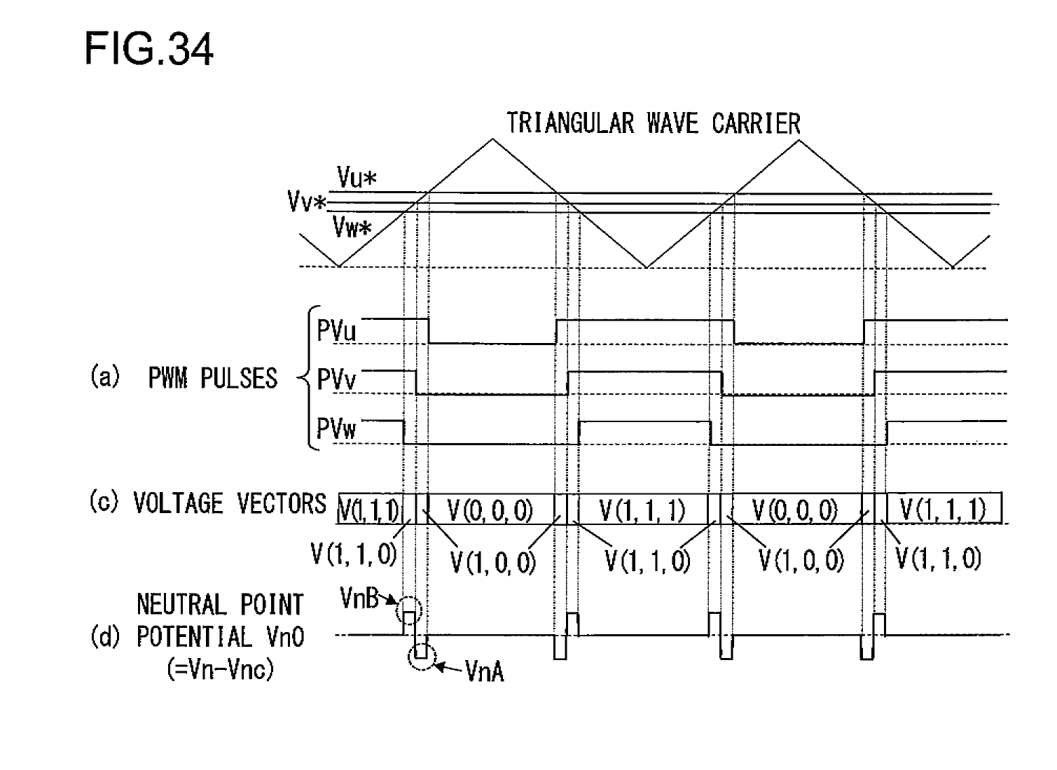

In the conditions shown in FIG. 2(a), the PWM waveforms become as shown in FIG. 34(a). FIG. 34 is a figure relating to conventional PWM control, showing the PWM waveforms, the neutral point potential waveform, and so on. In this PWM control method for a three-phase inverter, a conventional method of comparison with a triangular wave is used. As shown in FIG. 34, the PWM pulse waveforms PVu, PVv, and PVw as shown in FIG. 34(a) are generated by comparing the three-phase voltage commands Vu*, Vv*, and Vw* with a triangular wave carrier. It should be understood that, although the three-phase voltage commands Vu*, Vv*, and Vw* define waveforms of sine wave form, when considered at some instant, they may be viewed as being substantially DC, as for the case of Vu*, Vv*, and Vw* shown in FIG. 34, since during low speed operation it is possible to consider their frequencies as being sufficiently low as compared to that of the triangular wave carrier.

PVu, PVv, and PVw, which are PWM pulses, go repeatedly ON and OFF at mutually different timings. The voltage vectors of FIG. 34(c) represent the switched states of the U, V, and W phases, as described above. For example, V(1,0,0) means that: for the U phase, PVu=1; for the V phase, PVv=0; and, for the W phase, PVw=0. V(0,0,0) and V(1,1,1) are the zero vectors, for which the voltages supplied to the motor 4 become zero.

As shown in FIG. 34(c), with normal PWM pulse waves, the two voltage vectors V(1,0,0) and V(1,1,0) are generated between the first zero vector V(0,0,0) and the second zero vector V(1,1,1). In other words, the vector generation pattern “V(0,0,0)→V(1,0,0)→V(1,1,0)→V(1,1,1)→V(1,1,0)→V(1,0,0)→V(0,0,0)” is taken as one full cycle and repeated. As for the voltage vectors that are used between these zero vectors, the same ones are used while the magnitude relationship of the three-phase voltage commands Vu*, Vv*, and Vw* does not change. If the conventional triangular wave comparison method of an inverter used for PWM control is employed in this manner, the voltage vectors are naturally allocated as shown in FIG. 34(c) and PWM signals are generated that correspond to the voltage commands.

Next, the theory will be explained of the operation of the neutral point potential amplifier 13, of the sample/hold circuit 14b, of the position estimator 15, of the voltage command generator 17 for initial position estimation 17, of the initial position estimation changeover switches 18a and 18b, and of the initial position estimator 19, which are the characteristic portions of this embodiment. First, before explanation of the theory of the operation of this embodiment, the following features (a) through (c) will be explained.

(a) Explanation of variation of the neutral point potential
(b) The relationship between the rotor position θd and the neutral point potential Vn0
(c) Estimation of the rotor position θd by using variation of the neutral point potential

### (a) Explanation of Variation of the Neutral Point Potential

The neutral point potential Vn0 of the motor 4 varies under the influence of the position of the rotor of the motor 4 (in other words, under the influence of the magnetic flux of the magnets). In this embodiment, as an application of this theory, the rotor position is estimated backwards from the change of the neutral point potential. Now, the theory of the variation of the neutral point potential will be explained.

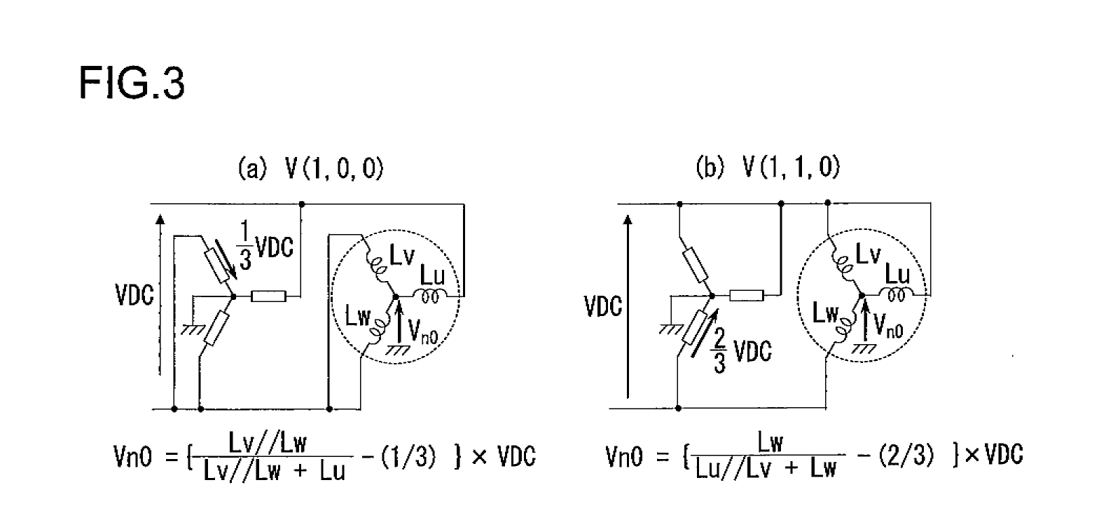

FIG. 3 is a concept diagram, conceptually showing the relationship between the motor 4 in certain states in which certain voltage vectors are applied, and the virtual neutral point circuit 34. FIG. 34(a) shows a case in which the voltage vector V(1,0,0) is applied, while FIG. 3(b) shows a case in which the voltage vector V(1,1,0) is applied. Since, as described above, the neutral point potential Vn0 is the difference between the potential Vn at the connection of the windings for three phases of the motor 4 and the virtual neutral point potential Vnc that is the output of the virtual neutral point circuit 34 (i.e. =Vn−Vnc), accordingly, when as shown in FIG. 3(a) the voltage vector V(1,0,0) is applied, the neutral point potential Vn0 is calculated according to Equation (1) below. On the other hand, when as shown in FIG. 3(b) the voltage vector V(1,1,0) is applied, the neutral point potential Vn0 is calculated according to Equation (2) below. Here, the symbols Lv//Lw and so on denote the combined inductance values of circuits that include the inductances Lv and Lw etc. in parallel; in concrete terms, their values are (Lv·Lw)/(Lv+Lw) etc.

Vn0={(Lv//Lw)/(Lv//Lw+Lu)−(⅓)}×VDC (1)

Vn0={Lw/(Lu//Lv+Lw)−(⅓)}×VDC (2)

If all the winding inductances Lu, Lv, and Lw for each of the three phases are equal in Equations (1) and (2), then the neutral point potential Vn0 can only become zero. However, in an actual permanent magnet motor, some influence is experienced due to the magnetic flux of the permanent magnets of the rotor, and small differences in the inductances inevitably occur. Due to these differences in the inductances, the neutral point potential Vn0 fluctuates.

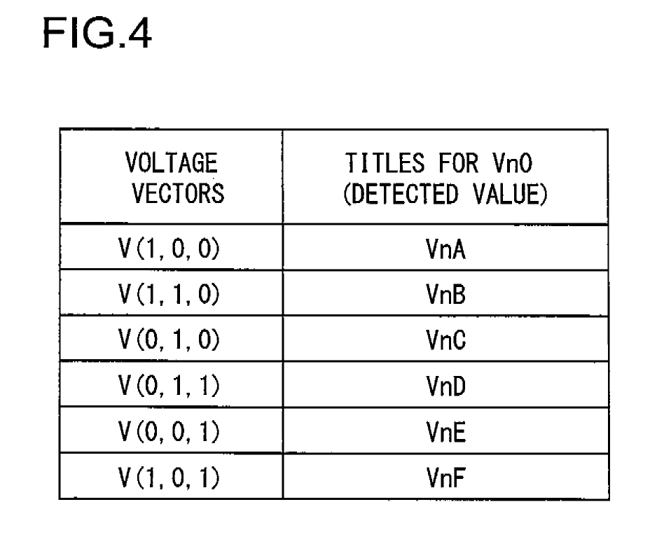

FIG. 4 is a figure showing the relationship between the switched states of the inverter 3 (in other words, the voltage vectors) and the neutral point potentials obtained at those times. In FIG. 4, the titles given to the neutral point potentials in the voltage vectors (i.e., switched states) V(1,0,0) through V(1,0,1) are, in order, VnA, VnB, VnC, VnD, VnE, and VnF.

### (b) the Relationship Between the Rotor Position θd and the Neutral Point Potential Vn0

Next, the relationship between the rotor position θd and the neutral point potential Vn0 (VnA through VnF) will be explained. The neutral point potential Vn0 is generated due to the values of the inductances Lu, Lv, and Lw of the various phases changing under the influence of the magnetic flux of the magnets, as shown in Equations (1) and (2). Here, it is hypothesized that the inductances change as described below:

Lu=L0−Kf·|Φu|

Lv=L0−Kf·|Φv|

Lw=L0−Kf·|Φw| (3)

In the above equations, L0 is the inductance when unsaturated, Φu, Φv, and Φw are the amounts of magnetic flux for each phase, and Kf is a coefficient. It is possible to express the changes of inductance corresponding to the amounts of magnetic flux by writing the inductances as shown in Equations (3). Moreover, the amounts of magnetic flux for the various phases may be expressed as shown below.

Φu=Φm·cos(θd)

Φv=Φm·cos(θd−2π/3)

Φw=Φm·cos(θd+2π/3) (4)

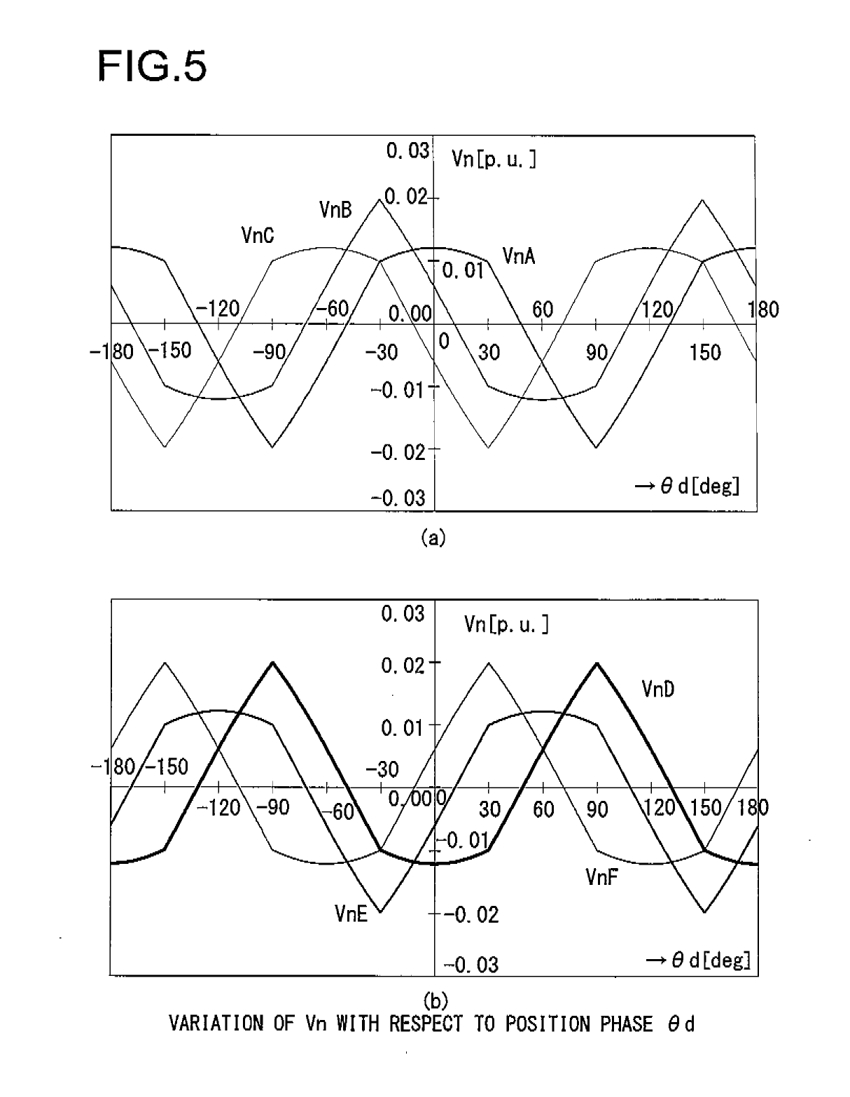

In the above Equations, Φm is the magnetic flux of the permanent magnets, and θd is the d axis phase. When Equations (4) are substituted into Equations (3), and the changes of the neutral point potential are calculated with the various voltage vectors as in Equations (1) and (2), then the patterns of FIG. 5 result.

### (c) Estimation of the Rotor Position θd by Using Variations of the Neutral Point Potential

Next, the method for estimating the rotor position θd by using variations of the neutral point potential will be explained. As shown in FIG. 5, it is understood that the neutral point potential VnA through VnF for each of the voltage vectors changes in dependence on the corresponding rotor position (i.e. the phase) θd. However, it is not possible to specify the phase (i.e. the rotor position) θd by only using the neutral point potential that corresponds to a single voltage vector. Due to this, in the prior art, the phase is specified by using a minimum of two such neutral point potentials. However, since the neutral point potential changes through two cycles during a single cycle of the rotor phase, accordingly, as explained hereinafter, it is only possible to obtain the rotor position over a range of ±90°.

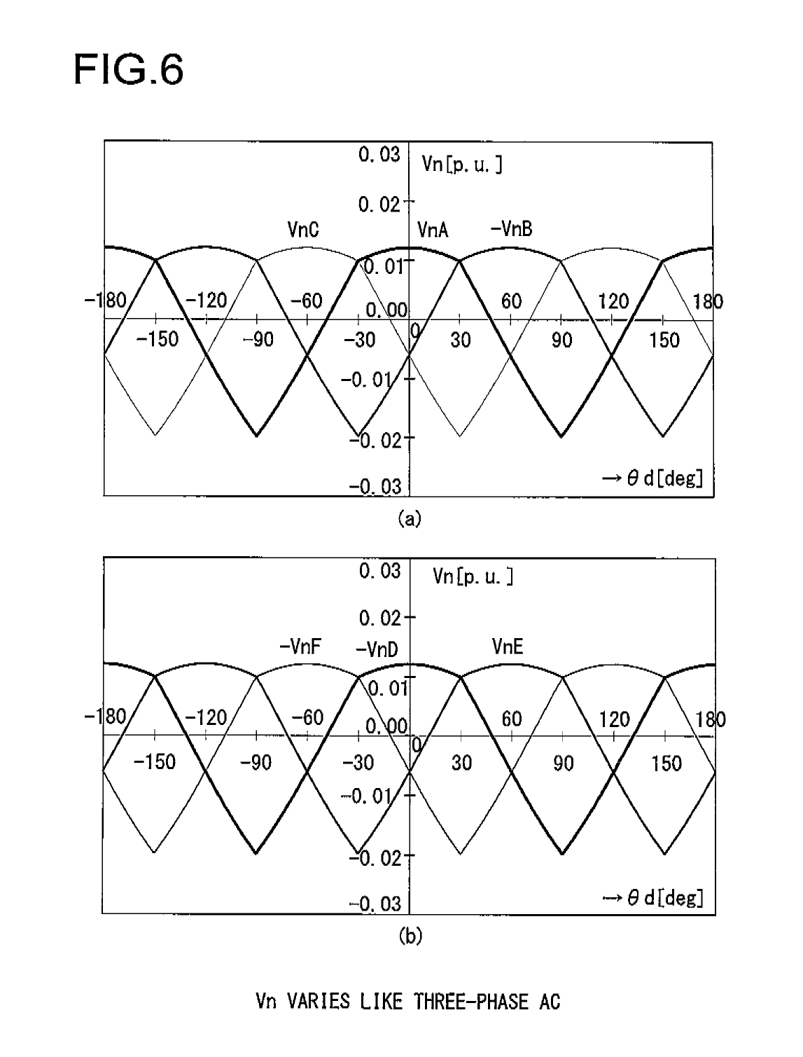

As shown in FIG. 5, each of the neutral point potentials VnA through VnF exhibits its own complicated pattern of change. However, if the patterns for VnB, VnD, and VnF among the six neutral point potentials shown in FIG. 5 are inverted, then waveforms as shown in FIG. 6 are obtained. As will be clear when these waveforms are inspected, it can be determined that they have come to define symmetric three-phase AC waveforms. Thus, estimation of the position of the rotor may be performed by taking advantage of the characteristic that these three phases are symmetric.

Then, it was conceived of to perform three-phase to two-phase conversion (α-β conversion) upon the three-phase AC amounts Xu, Xv, and Xw. The equations for three-phase to two-phase conversion may be expressed as the following Equations (5):

Xa=(⅔)·{Xu−(½)·Xv−(½)·Xw}

Xb=(⅔)·{(√(3)/2)·Xv−(√(3)/2)·Xw} (5)

For example, if the three neutral point potentials VnA, VnB, and VnC have been obtained, then Xu, Xv, and Xw are set as in Equations (6) below. This corresponds to FIG. 6(a). It should be understood, from the characteristics of three-phase AC, that if two of the neutral point potentials VnB and VnA are available as in FIG. 34(d), then it is possible to obtain the neutral point potential for the other phase by calculation (i.e. by derivation according to the relationship Xu+Xv+Xw). And, when Equation (6) is substituted into Equations (5), Xa and Xb can be derived. As a result, the calculated value θdc for the rotor position θd may be obtained according to Equation (7) below. It should be understood that “arctan” in Equation (7) means the arc tangent function.

Xu=VnA, Xv=−VnB, Xw=VnC (6)

θdc=(½)arctan(Xb/Xa) (7)

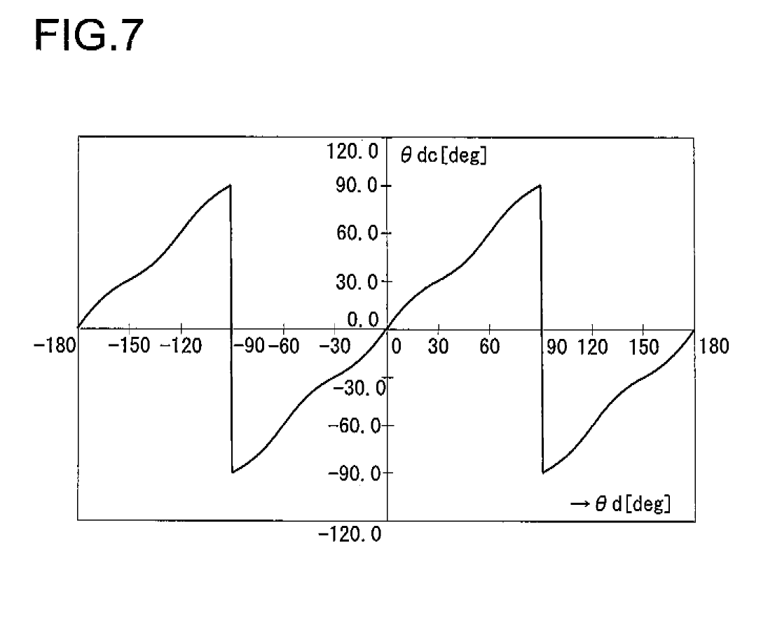

FIG. 7 is a figure showing a comparison between the result for θdc calculated according to Equation (7) and the rotor position θd (i.e. the phase angle). It will be understood that it is possible to calculate the rotor position θd almost accurately. However it will also be understood that, since θdc changes through two cycles during a single cycle of rotor phase, accordingly phase information can only be obtained over a range of ±90°.

In this manner, with conventional PWM control, it is possible only to perform position estimation for one half cycle of the electrical angle cycle (i.e. over ±90°). Due to this, if an attempt is made to start the motor 4 directly after the power supply to the inverter 3 has been turned ON, then there is a possibility that an error of 180° may be included in the estimated position of the rotor, and there is a probability of ½ that the motor may rotate in the wrong direction.

(Estimation of the Rotor Position θd in this Embodiment)

While, as described above, with motor drive control according to the prior art, it has only been possible to perform position estimation over a half cycle (±90°) of electrical angle, by contrast this problem is solved with the drive control device 100 of this embodiment, and, as will be explained below, it is arranged to obtain position information over a rotor phase angle range of ±180° (i.e. over a full cycle of electrical angle). The characteristic portions of this embodiment are the position estimator 15, the voltage command generator 17 for initial position estimation, the initial position estimation changeover switches 18a and 18b, and the initial position estimator 19 shown in FIG. 1.

The position estimator 15 is a section that performs position estimation calculation according to Equations (5) through (7) described above during normal driving of the motor 4 (i.e. during motor drive). By contrast, the voltage command generator 17 for initial position estimation and the initial position estimator 19 are control blocks for estimating the initial position of the rotor of the motor 4. The initial position estimation changeover switches 18a and 18b are changed over to their “0” sides during normal driving (i.e. after rotation has been started), and are changed over to their “1” sides during initial position estimation (i.e. when rotation is being started). By changing over the initial position estimation changeover switches 18a and 18b to their “1” sides, the control blocks for estimating the rotor initial position are caused to function.

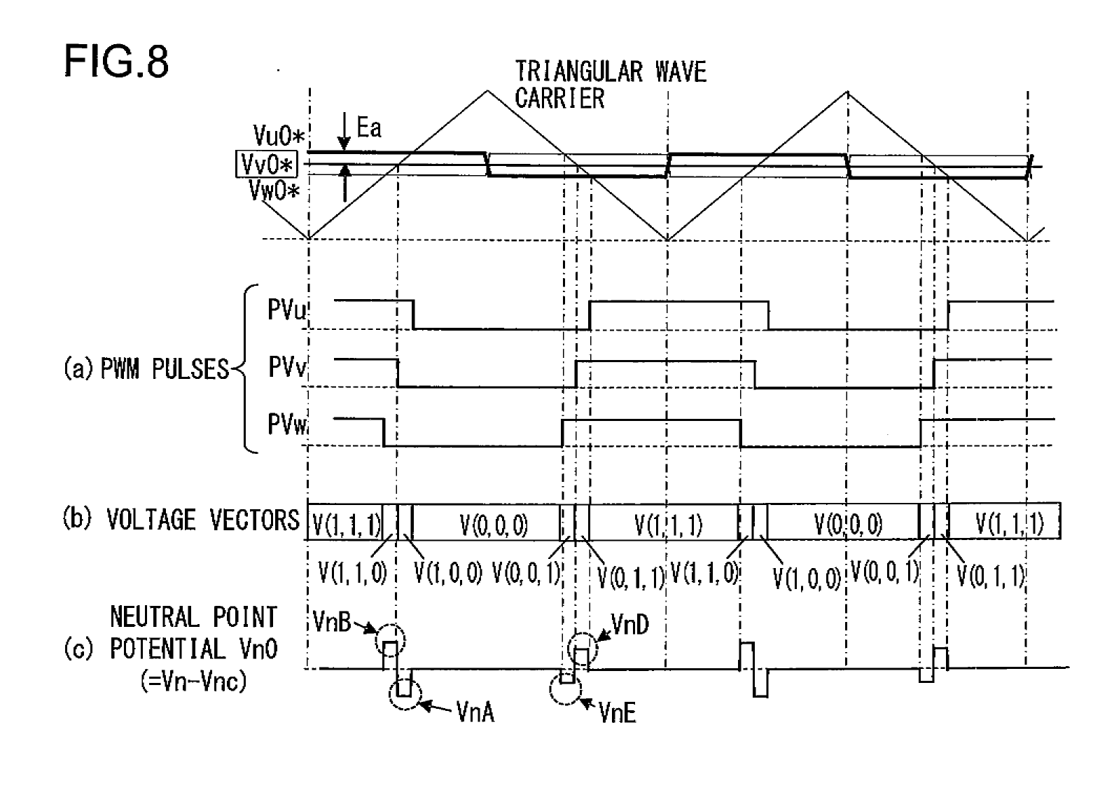

The voltage command generator 17 for initial position estimation outputs three-phase voltage commands Vu0*, Vv0*, and Vw0* for estimating the initial position of the rotor. FIG. 8 is a figure showing these three-phase voltage commands Vu0*, Vv0*, and Vw0*. FIG. 8 shows the PWM pulses (FIG. 8(a)), the voltage vectors (FIG. 8(b)), and the neutral point potential Vn0 (FIG. 8(c)) when, in this embodiment, the three-phase voltage commands Vu0*, Vv0*, and Vw0* are generated for a triangular wave carrier.

If voltages whose average is zero are not applied during initial position estimation, then the result is that a torque is generated by the motor 4. Thus, as shown in FIG. 8, it is arranged to change over the polarities of the three-phase voltage commands on a fixed cycle. In other words, in order from above over the rising range of the triangular wave carrier, they are Vu0*, Vv0*, and Vw0* and the gaps between them are all made to be equal to Ea. On the other hand, in order from above over the falling range of the triangular wave carrier, they are Vw0*, Vv0*, and Vu0* and the gaps between them are all made to be equal to Ea. While there is no problem with this changeover cycle if it is sufficiently short with respect to the electrical time constant of the motor 4, its influence is reduced if it is kept to the necessary minimum. For example, as will be described hereinafter, even during starting of rotation (i.e. during initial position estimation), the rotor may not always be perfectly stopped, and in this type of case it is desirable to estimate the initial position in as short a period of time as possible under almost the same conditions. While, in FIG. 8, in order to keep the time period down to the necessary minimum, changing over is performed at each half cycle of the triangular wave cycle used in PWM, a changing over cycle may be somewhat longer or shorter than the half cycle.

When the voltage commands Vu0*, Vv0*, and Vw0* shown in FIG. 8 are outputted from the voltage command generator 17 for initial position estimation, voltage vectors of four different types come to be applied to the motor 4. In the case of the voltage commands Vu0*, Vv0*, and Vw0* shown in FIG. 8, apart from the zero vectors V(0,0,0) and V(1,1,1), the four types of voltage vectors V(1,1,0), V(1,0,0), V(0,0,1), and V(0,1,1) are applied. And, corresponding to each of these voltage vectors, the neutral point potentials VnB, VnA, VnE, and VnD of four types are detected in order. The initial position is estimated by the initial position estimator 19 on the basis of the detected values of these neutral point potentials.

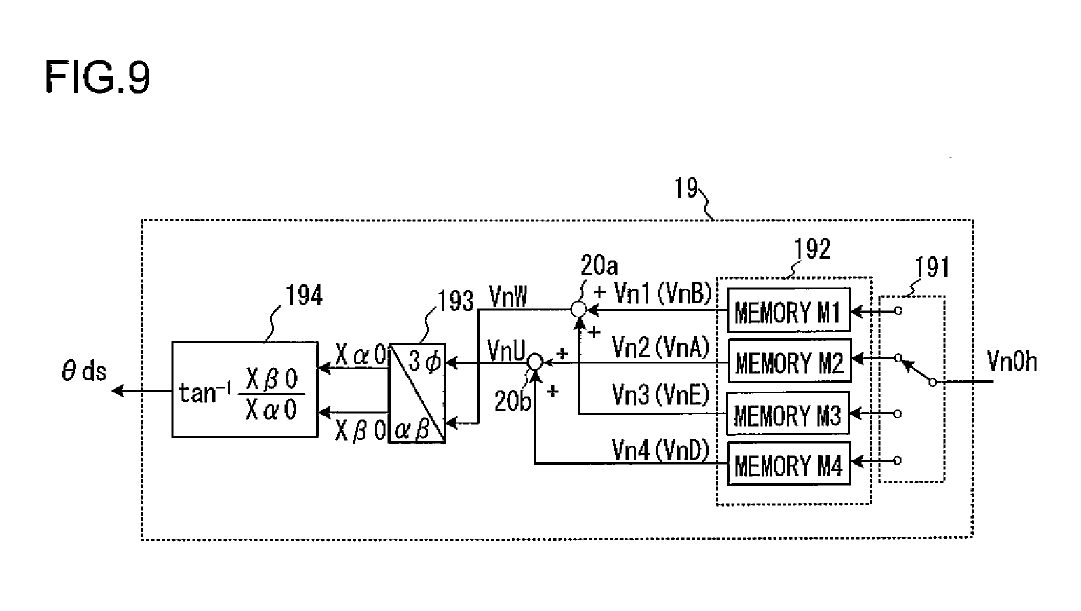

FIG. 9 is a block diagram showing the initial position estimator 19. Since the initial position estimation changeover switch 18b shown in FIG. 1 is changed over to the “1” side during the initial position estimation, accordingly the sample/hold value Vn0h of the neutral point potential Vn0 is inputted to the initial position estimator 19 from the sample/hold circuit 14b. The sample/hold value Vn0h is allocated to a neutral point potential memory 192 by a neutral point potential changeover switch 191. In the example shown in FIGS. 8 and 9, the neutral point potential VnB is stored in a memory M1, the neutral point potential VnA is stored in a memory M2, the neutral point potential VnE is stored in a memory M3, and the neutral point potential VnD is stored in a memory M4.

And calculation is performed by adders 20a and 20b to add together the detected values of the neutral point potentials. The neutral point potential VnB from the memory M1 and the neutral point potential VnE from the memory M3 are added together by the adder 20a. And the neutral point potential VnA from the memory M2 and the neutral point potential VnD from the memory M4 are added together by the adder 20b. Signals of the results of addition by the adders 20a and 20b being viewed as three-phase AC are taken as VnU and VnW, and these signals are converted by an α-β converter 193 into α-β converted values Xα0 and Xβ0. On the basis of these α-β converted values Xα0 and Xβ0, calculation of phase angle is performed by an arc tangent calculator 194, so that the initial phase θds is obtained over a full range of ±180°. And during normal operation (i.e. after rotation has started), phase estimation is performed by the position estimator 15 while taking this θds as initial value.

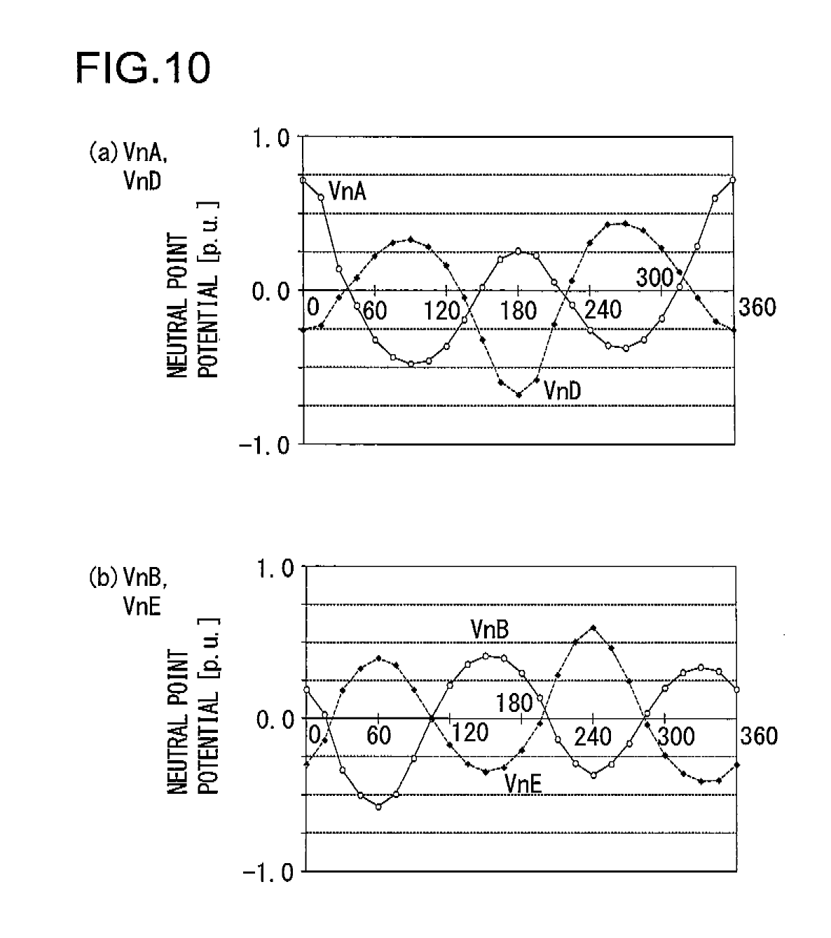

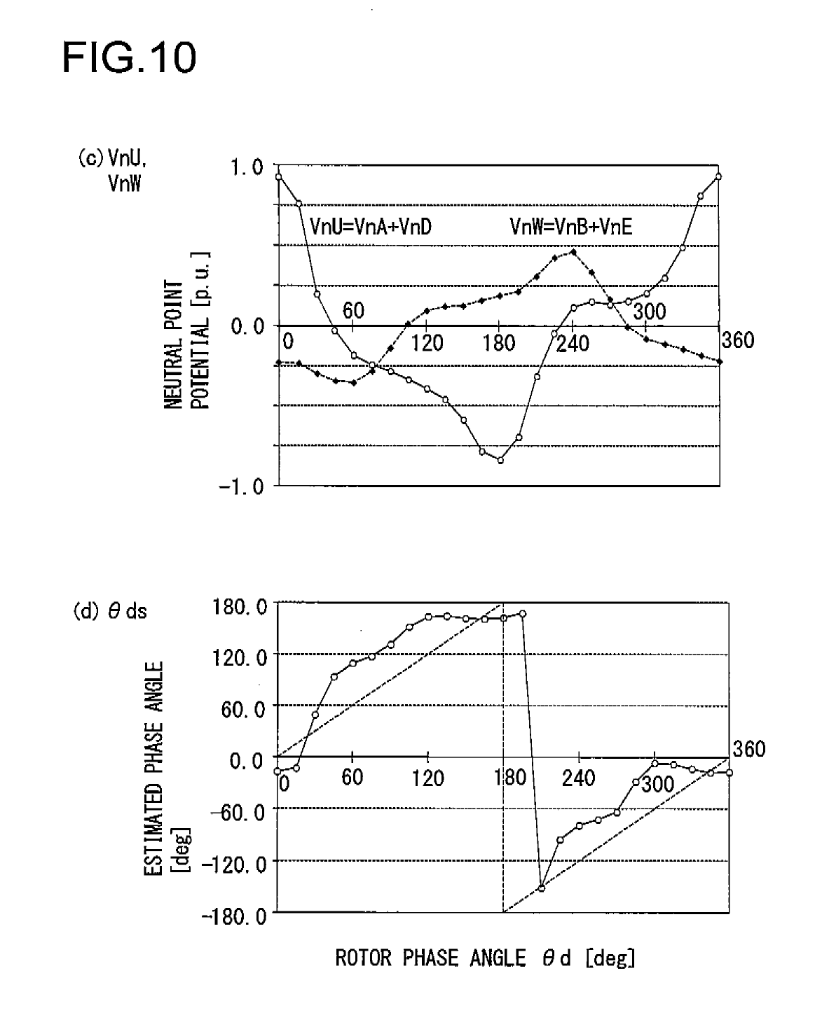

Next, the theory of the operation of the initial position estimator 19 will be explained with reference to FIG. 10. FIG. 10 is a figure showing the four neutral point potential waveforms that are obtained when the voltages shown in FIG. 8 are applied to the motor 4. FIG. 10(a) is a graph showing the neutral point potentials VnA and VnD, while FIG. 10(b) is a figure showing the neutral point potentials VnB and VnE.

While the neutral point potential VnA and the neutral point potential VnD exhibit symmetrical variations, this phenomenon originates in the fact that the voltage vector V(1,0,0) for which the neutral point potential VnA is obtained and the voltage vector V(0,1,1) for which the neutral point potential VnD is obtained are vectors of opposite orientation (refer to FIG. 2). In a similar manner, the neutral point potential VnB that is obtained by applying the voltage vector V(1,1,0) and the neutral point potential VnE that is obtained by applying the voltage vector V(0,0,1) of opposite orientation thereto exhibit symmetrical variations.

Furthermore, with respect to change of the rotor phase angle over one cycle, the neutral point potentials VnA, VnD, VnB, and VnE do not necessarily change with a half period, and it is understood that they clearly include components that change over a full cycle. This is because components are included that are not considered in the hypothesis described above (i.e. the hypothesis of Equations (3)). In concrete terms, these components originate due to the fact that the inductances are different from one another, because the components that are applied as the voltage vector either contribute to the magnetic flux of the magnets of the motor 4 in the direction to increase the magnetic field, or contribute in the direction to reduce the magnetic field. In other words, if a voltage is applied in the direction to increase the magnetic field, then the reduction of the inductance becomes great due to the fact that the magnetic saturation is promoted, while, conversely, if a voltage is applied in the direction to reduce the magnetic field, then the reduction of the inductance is less.

For example, for the neutral point potential VnA in FIG. 10(a), the values of the rotor phase angle θd in the vicinity of 180° are low, as compared to its values in the vicinity of 0° and 360°. This is because 0° operates in the direction to increase the magnetic field, while 180° operates in the direction to reduce the magnetic field. By contrast, for the neutral point potential VnD when the voltage vector in the opposite orientation is applied, the relationship is opposite to the case of the neutral potential VnA; in other words, the values (the absolute values) in the vicinity of 0° and 360° are low, as compared to the values in the vicinity of 180°.

It will be understood that information about the polarities of the rotor magnetic poles is included in the neutral point potentials in this manner. As described above, addition together of VnB and VnE, which are the neutral point potentials when two of the voltage vectors that have mutually opposite orientation are applied, is performed by the adder 20a, and this is outputted as VnW. On the other hand, addition together of VnA and VnD, which are the neutral point potentials when the other two of the voltage vectors that have mutually opposite orientation are applied, is performed by the adder 20b, and this is outputted as VnU. FIG. 10(c) is a figure showing the variations of the values VnW and VnU that are the results of these additions, and from this it will be understood that the periodicity of the waveforms of VnW and VnU is one full cycle of electrical angle.

When α-β conversion is performed by the α-β converter 193 on the basis of these combined values VnW and VnU, and the phase angle is obtained by the arc tangent calculator 194, then the estimated phase angle θds as shown in FIG. 10(d) is obtained. Although some error is included in this estimated phase angle θds, this is an error of around 60° in electrical angle, and mistaken reverse rotation will not occur even though motor starting (i.e. starting of rotation) is performed while using this estimated phase angle θds.

In other words, according to this embodiment, the four switching vectors, i.e. the switching vectors V(1,1,0) and V(0,0,1) that have mutually opposite orientations and the switching vectors V(1,0,0) and V(0,1,1) that have mutually opposite orientations, are obtained by the voltage commands Vu0*, Vv0*, and Vw0* being outputted from the voltage command generator 17 for initial position estimation, as shown in FIG. 8. And it is possible to obtain the rotor position instantaneously over a range of ±180° (electrical angle cycle) by estimating the estimated phase angle θds with the initial position estimator 19, on the basis of the four neutral point potentials VnA, VnD, VnB, and VnE that are respectively detected on the basis of these switching vectors. Due to this, along with it becoming possible to shorten the time period required for starting the motor, also it is possible reliably to prevent reverse rotation when rotation is being started.

### Second Embodiment

Next, a second embodiment of the present invention will be explained. In the first embodiment described above, four voltage vectors other than the zero vectors are applied to the motor 4, the neutral point potential when each of these vectors is applied is detected, and detection of the position of the rotor in the electrical angle cycle is performed (i.e. the estimated phase angle θds is estimated). While it becomes possible to perform position estimation over the electrical angle cycle by doing this, as shown in FIG. 10(d), the actual accuracy of position estimation is not itself very high. This problem originates in the fact that components of one electrical angle cycle are extracted that are only slightly included in the detected neutral point potentials, and position estimation is performed on the basis of their values. Due to this, a shortage of torque may occur if the error in the estimated phase is great, and there is a possibility that quickly responsive starting may become difficult.

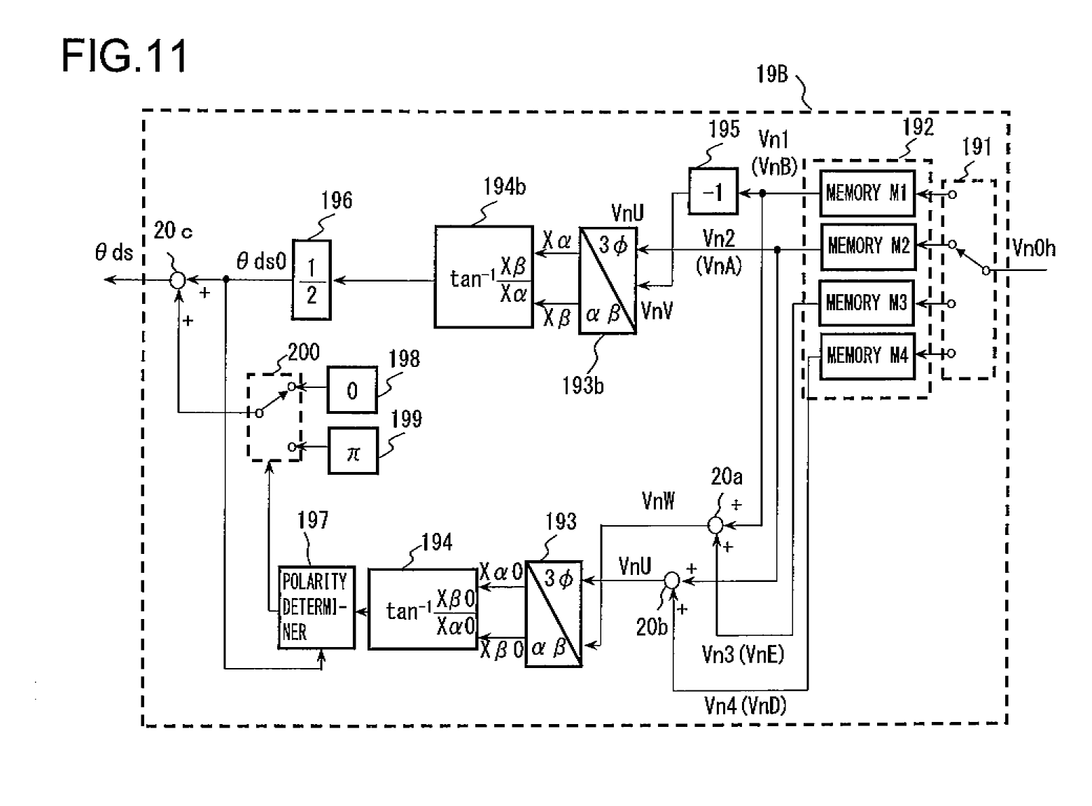

Accordingly the accuracy of the initial position estimation is enhanced in this second embodiment, so that this type of problem is solved. FIG. 11 is a block diagram of an initial position estimator 19B, showing the characteristic portions of this second embodiment. The drive control device 100 of this second embodiment is one in which the initial position estimator 19 of FIG. 1 is replaced by the initial position estimator 19B of FIG. 11, and accordingly, in the following, explanation will be omitted of structures other than the initial position estimator 19B.

In FIG. 11, the same reference symbols are appended to structural elements that are the same as structural elements shown in FIG. 9. That is to say, the adders 20a and 20b, the neutral point potential changeover switch 191, the neutral point potential memory 192, the α-β converter 193, and the arc tangent calculator 194 are the same as those shown in FIG. 9. Moreover, an adder 20c, an α-β converter 193b, and an arc tangent calculator 194b are blocks that perform similar operations to those of the adder 20a, the α-β converter 193, and the arc tangent calculator 194 shown in FIG. 9. A sign inversion gain 195, a half gain 196, a polarity determiner 197, a zero generator 198, a it generator 199, and a polarity changeover switch 200 are components in FIG. 11 that are newly added and that operate differently.

Next, the operation of this second embodiment will be explained. When three-phase voltage commands Vu0*, Vv0*, and Vw0* similar to those shown in FIG. 8 are outputted from the voltage command generator 17 for initial position estimation, the neutral point potentials VnA, VnB, VnE, and VnD are stored in the memories M1 through M4 of the neutral point potential memory 192, in a similar manner to the case with the first embodiment. Of course, due to the manner of output (i.e. the magnitude relationship) of these three-phase voltage commands Vu0*, Vv0*, and Vw0*, the four among the VnA through VnF shown in FIG. 4 to be stored in the memories M1 through M4 are different. Thus, neutral point potentials stored in the memories M1 through M4 are designated in order as Vn1, Vn2, Vn3, and Vn4. In the following, the explanation will be made in terms of Vn1=VnB, Vn2=VnA, Vn3=VnE, and Vn4=VnD.

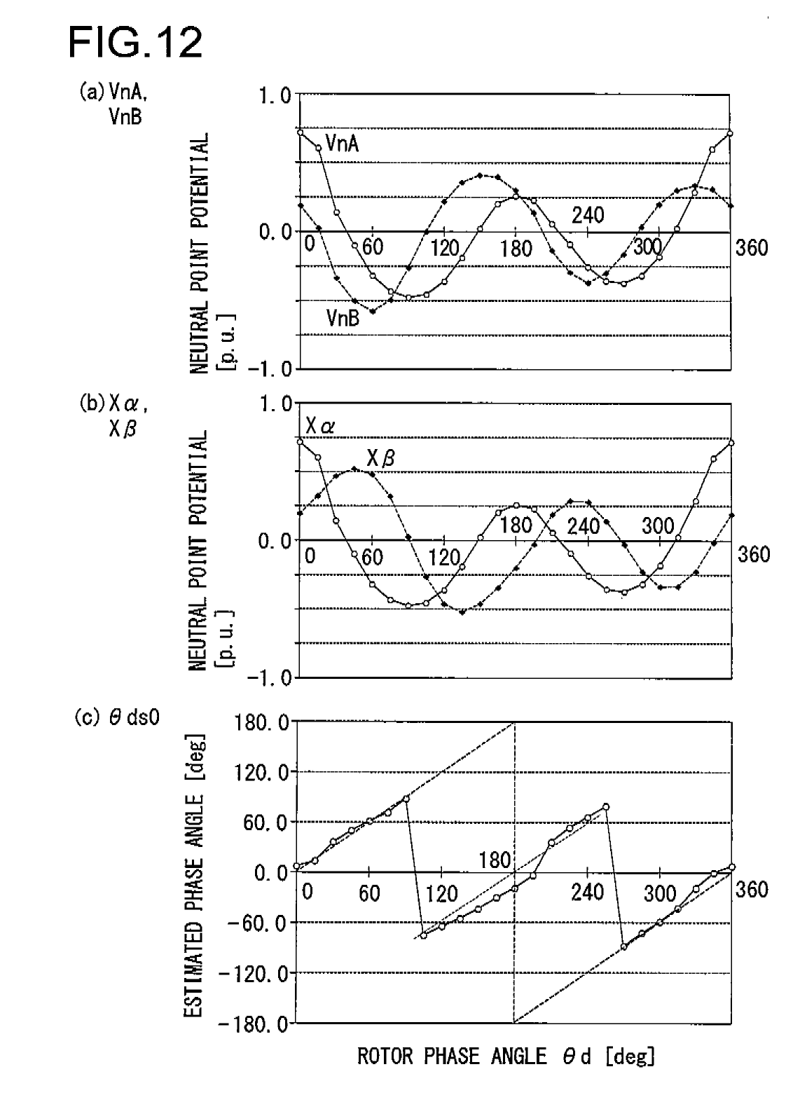

The waveforms of the neutral point potentials VnA and VnB change with respect to the rotor phase, as shown in FIG. 12(a). These waveforms are the same as the waveforms of VnA and VnB shown in FIGS. 10(a) and 10(b). The variation of these waveforms appears to be quite close to that of the theoretical waveforms derived from Equations (3) and (4) (refer to FIG. 5).

Along with the neutral point potential Vn2 (VnA) being inputted to the α-β converter 193b as VnU, also the neutral point potential Vn1 (VnB) is sign inverted by the sign inversion gain 195 and then is inputted as VnV. As shown in FIG. 6, by inverting the sign of Vn1 (VnB) and by taking Vn2 (VnA) and Vn1 (VnB) as a three-phase AC signal, coordinate conversion is performed by the α-β converter 193b. When coordinate conversion is thus performed by the α-β converter 193b, waveforms like those shown in FIG. 12(b) are obtained.

Calculation is performed by the arc tangent calculator 194b on the basis of the α-β converted values Xα and Xβ outputted from the α-β converter 193b, and, by processing being performed by the half gain 196 on the result of this calculation, the phase angle shown in Equation (7) described above is obtained as the final calculation result. This calculation result is shown in FIG. 12(c). Although an error at 180° with respect to the actual rotor phase angle θd is present in the range from 90° to 270°, when a comparison with the waveform of the estimated phase angle θds in the first embodiment is performed (refer to FIG. 10(d)), the accuracy of position estimation is greatly improved. Thus, here, the phase calculation result is taken as θds0 over the range of ±90°.

The blocks for the adders 20a and 20b, the α-β converter 193, and the arc tangent calculator 194 are sections that operate in the same manner as the corresponding blocks shown in FIG. 9 for the first embodiment, and thus the result being that the phase angle of the waveform from the arc tangent calculator 194 shown in FIG. 10(d) is outputted as the calculation result.

The polarity determiner 197 compares together θds0 outputted from the half gain 196 and the result of calculation by the arc tangent calculator 194. And, if the difference between them is greater than a predetermined value (for example, if the absolute value of the difference is greater than 90°, or the like), then the polarity determiner 197 determines that the polarity of θds0 is inverted, and changes over the polarity changeover switch 200 to the π generator 199. As a result, 180° (i.e. π) is added to θds0 by the adder 20c, and this value to which π has been added is outputted from the initial position estimator 19B as the estimated phase angle θds. Conversely if it is determined by the polarity determiner 197 that the deviation is small, then the polarity changeover switch 200 is changed over to the zero generator 198, and zero is added to θds0 by the adder 20c. In other words, the calculated value θds0 is outputted just as it is without alteration from the initial position estimator 19B as the estimated phase angle θds.

In this embodiment, in order to enhance the accuracy of position estimation, θds0 is used, whose accuracy is high due to its having been calculated on the basis of the difference between the two neutral point potentials VnA and VnB, as described above. However, since θds0 can only be used over the range of ±90°, accordingly, by comparing this calculated result θds0 with the estimated phase angle θds that is calculated using the four vectors, it is arranged to distinguish whether this θds0 that has been calculated is a value within the range of ±90°, or whether it is a value that is outside this range. And, if θds0 is a value that is within the range of ±90°, then its calculated value θds0 is employed as the estimated phase angle θds just as it is without alteration; whereas, if it is determined to be a value outside that range, then it is arranged to obtain the correct estimated phase angle θds by adding 180°. By performing this type of processing, it becomes possible to estimate the rotor position over the entire range of the electrical angle cycle. Moreover, since the accuracy of phase estimation is greatly improved as compared to the case with the first embodiment, accordingly it becomes difficult for any problem such as torque shortage during starting or the like to occur.

It should be understood that while, in the example described above, when three-phase voltage commands Vu0*, Vv0*, and Vw0* having the magnitude relationship shown in FIG. 8 are outputted from the voltage command generator 17 for initial position estimation, then θds0 is calculated using the two neutral point potentials VnA and VnB, this is only an example, and it would also be acceptable to use VnD and VnE as the two neutral point potentials.

Moreover it should be understood that, when the switched states are expressed as a vector on the stator coordinate axes as shown in FIG. 2, then the four voltage vectors (i.e. switching vectors) have the relationship that they can be divided into two pairs of vectors, each of which is made up of two voltage vectors in mutually opposite orientations (for example, the pair of vectors consisting of the two voltage vectors V(1,0,0) and V(0,1,1)). Due to this, here, it is arranged to calculate θds0 on the basis of the difference between the neutral point potentials corresponding to voltage vectors that are oriented in the same direction. In the example described above, the vector pairs in the two groups are the vector pair consisting of the voltage vectors V(1,0,0) and V(0,1,1) that are in mutually opposite orientations and the vector pair consisting of the voltage vectors V(1,1,0) and V(0,0,1) that are in mutually opposite orientations, and θds0 is calculated by using the neutral point potentials VnA and VnB corresponding to the voltage vectors V(1,0,0) and V(1,1,0) that are oriented in the same direction. However, it would also be acceptable to calculate θds0 by using the neutral point potentials VnD and VnE for the voltage vectors V(0,1,1) and V(1,1,0) that are oriented in the same direction.

### Third Embodiment

Next, a third embodiment of the present invention will be explained. In the first and second embodiments described above are systems in which four voltage vectors, excluding the zero vectors, are applied to the motor 4, the neutral point potential when each of these vectors is applied is detected, and detection of the rotor position is performed over the entire electrical angle cycle. In either case, while it is necessary to apply four voltage vectors, it is desirable to use only the necessary minimum limit of neutral point potential information, in order to perform the processing for the position estimation algorithm in as convenient a manner as possible. Thus, in the third embodiment explained below, it is arranged to perform position estimation over the entire range of the electrical angle cycle by using voltage vectors of three types, excluding zero vectors.

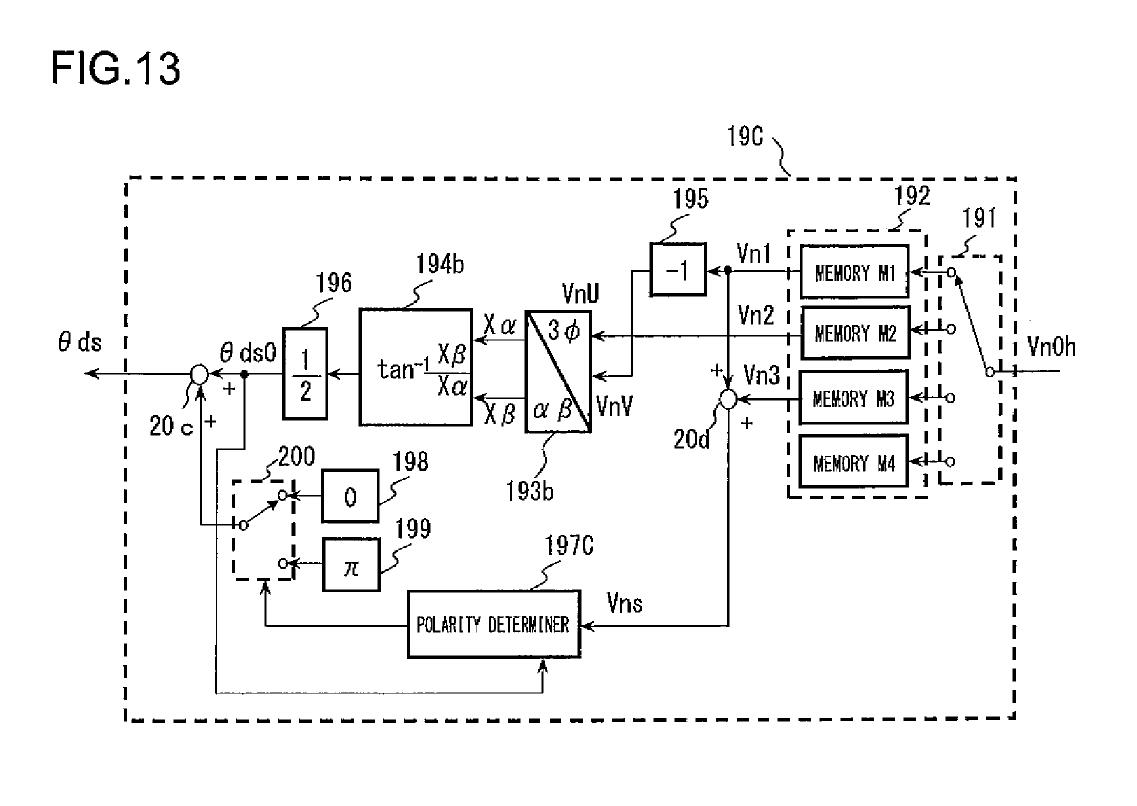

FIG. 13 is a block diagram of an initial position estimator 19C, this being the characteristic portion of this third embodiment. The third embodiment is obtained by employing this initial position estimator 19C instead of the initial position estimator 19 of the controller 2 shown in FIG. 1. In FIG. 13, the adder 20c, the neutral point potential changeover switch 191, the neutral point potential memory 192, the α-β converter 193b, the arc tangent calculator 194b, the sign inversion gain 195, the half gain 196, the zero generator 198, the it generator 199, and the polarity changeover switch 200 are elements to which the same reference symbols are appended as those shown in FIG. 11, and that operate in the same ways. Moreover, the initial position estimator 19C includes a polarity determiner 197C in place of the polarity determiner as shown in FIG. 11. It should be understood that an adder 20d operates in the same manner as the adder 20c.

Next, the operation of this embodiment will be explained. The neutral point potentials Vn1 through Vn3 that are stored in the memories M1 through M3 are any three of the neutral point potentials VnA through VnF shown in FIG. 4. However, since the neutral point potentials detected as in FIG. 8 are stored in the memories M1 through M3 in order, accordingly the neutral point potential Vn1 and the neutral point potential Vn3 are neutral point potentials when voltage vectors having mutually opposite orientations are applied. When three-phase voltage commands Vu0*, Vv0*, and Vw0* similar to those in the case of FIG. 8 are outputted from the voltage command generator 17 for initial position estimation, then Vn1=VnB, Vn2=VnA, and Vn3=VnE.

In a similar manner to the case in FIG. 11, along with the neutral point potential Vn1 whose sign has been inverted by the sign inversion gain 195 being inputted to the α-β converter 193b as VnV, also Vn2 in the memory M2 is inputted as VnU. And the phase θds0 of the rotor is obtained by α-β conversion being performed by the α-β converter 193b, by calculation being performed by the arc tangent calculator 194b, and processing being performed by the half gain 196. The processing performed by these sections is the same as in the case of the second embodiment described above, and thereby the phase θds0 is obtained as shown in FIG. 12(c).

Apart from calculation of the rotor phase θds0, also polarity determination is performed as follows. First, the neutral point potential Vn1 and the neutral point potential Vn3 are added together by the adder 20d. Next, the polarity of the magnetic poles of the rotor is determined from the result Vns of this addition outputted from the adder 20d and the calculated value of θds0. As described above, the voltage vector for which the neutral point potential Vn3 is detected is a vector that is opposite to the voltage vector for which the neutral point potential Vn1 is detected. Here, since Vn1=VnB, accordingly, with Vn3=VnE, Vns=VnB+VnE. Moreover, if Vn1=VnA, then, with Vn3=VnD, Vns=VnA+VnD.

For example, if Vns=VnA+VnD, then, as shown in FIG. 10(c), it will be understood that it has its peak values near the phase angles 0° and 180°, and moreover that these polarities are opposite. On the other hand, if Vns=VnB+VnE, then the same phenomenon appears near the phase angles 60° and 240°.

The determination by the polarity determiner 197C when, for example, Vns=VnB+VnE is used will now be explained with reference to FIG. 10(c) and FIG. 12(c). A correlation relationship like that shown in FIG. 10(c) between the rotor phase angle θd and Vns is stored in advance in the polarity determiner 197C. The polarity determiner 197C performs polarity determination from the calculated Vns and θds0, and from this correlation relationship.

If, for example, 60° has been obtained as the phase θds0, then, since the phase θds0 has a waveform like that shown in FIG. 12(d), it is considered that this is either the case of the rotor phase angle θd being 60° or the case of it being 240°. And, when the sign of Vns for the case of θd=60° and for the case of θd=240° is investigated with reference to FIG. 10(c), it will be understood that Vns is negative for the case of θd=60°, while it is positive for the case of θd=240°.

If the Vns that is inputted is negative, then the polarity determiner 197C changes over the polarity changeover switch 200 to the zero generator 198. As a result, θds0 is outputted just as it is without alteration from the initial position estimator 19C as the estimated phase angle θds. Conversely, if the Vns that is inputted is positive, then the polarity determiner 197C changes over the polarity changeover switch 200 to the π generator 199. As a result 180° (in other words, π) is added to θds0 by the adder 20c, and the result of this addition is outputted from the initial position estimator 19C as the estimated phase angle θds.

In this manner, with this third embodiment, among the four switching vectors, the difference between the neutral point potentials Vn1 (VnB) and Vn2 (VnA) for two switching vectors V(1,1,0) and V(1,0,0) that are oriented in the same direction is obtained, θds0 is obtained as first rotor position information on the basis of this difference, and furthermore the sum of the neutral point potentials Vn1 (VnB) and Vn3 (VnE) for one of those switching vectors V(1,1,0) and the switching vector V(0,0,1) that has the opposite orientation thereto is obtained. And the polarity of the magnetic flux of the rotor position is determined from θds0 and the value of this sum. In this manner, by using the estimated phase angle θds0 that has high accuracy over one half cycle of electrical angle, and the result of polarity determination, it is possible to estimate the rotor position with better accuracy over the entire range of electrical angle cycle. Moreover, by using this polarity determination that employs the two neutral point potentials, it becomes possible to implement a more convenient control algorithm.

### Fourth Embodiment

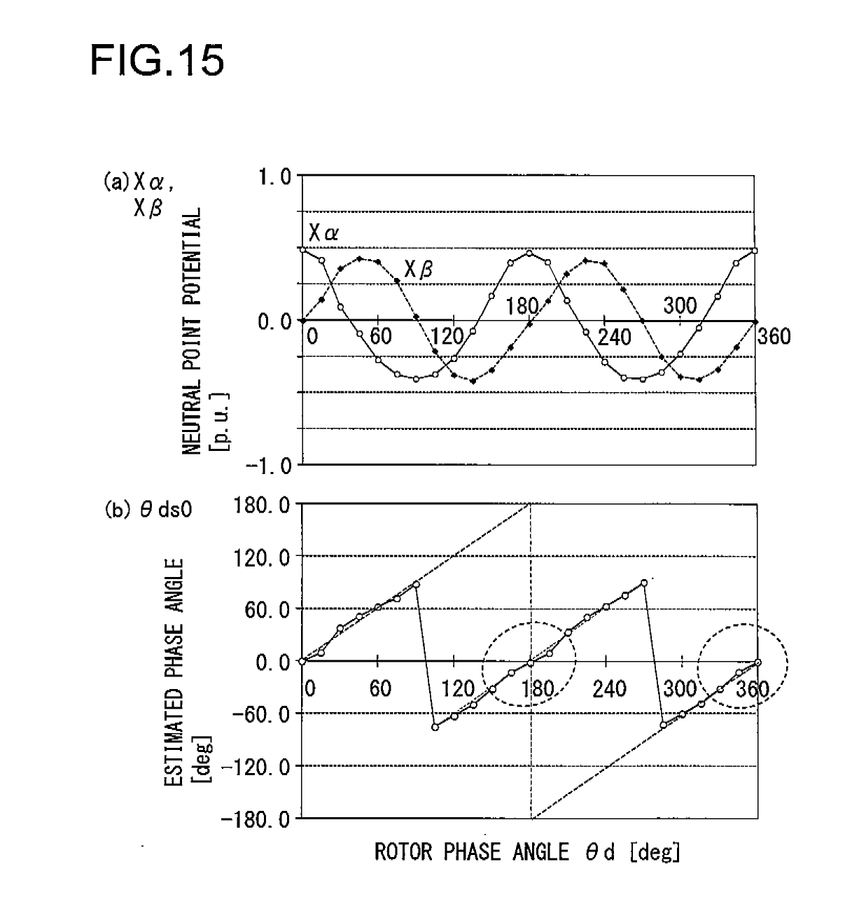

Next, a fourth embodiment of the present invention will be explained. In this fourth embodiment, in a similar manner to the cases of the first and the second embodiments, four voltage vectors, excluding the zero vectors, are applied to the motor 4, the neutral point potential when each of these vectors is applied is detected, and detection of the rotor position is performed over the entire electrical angle cycle; but, furthermore, the position estimation accuracy is greatly improved, as shown in FIG. 15(b).

As described in connection with the second embodiment, it is possible to perform position estimation over a range of ±90° by using two neutral point potentials, as shown in FIG. 12(c). While the result of this position estimation has quite high accuracy, as shown in FIG. 12(c), the error of estimation becomes somewhat greater, for example, in the vicinity of θd=180° or in the vicinity of θd=360°. This is due to the fact that, as shown in FIG. 12(a), the two neutral point potentials VnA and VnB have waveforms with large distortion with respect to the phase angle θd.

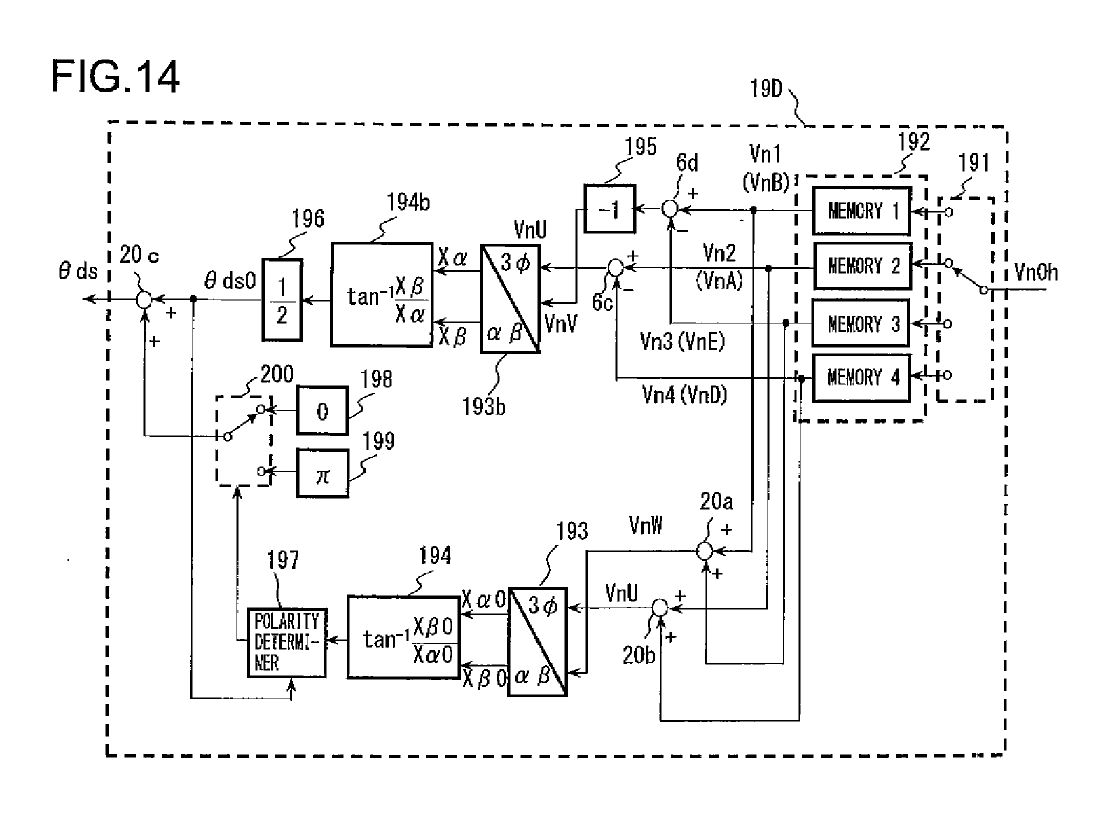

This fourth embodiment is one in which this distortion is suppressed, so that high accuracy initial position estimation can be implemented. FIG. 14 is a block diagram of an initial position estimator 19D, which is a characteristic portion of the fourth embodiment. The drive control device 100 of this fourth embodiment employs this initial position estimator 19D instead of the initial position estimator 19 shown in FIG. 1.

The structure of the initial position estimator 19D shown in FIG. 14 is the same as that of the initial position estimator 19B shown in FIG. 11, except for the fact that subtractors 6c and 6d are newly added. Now, explanation will be made, assuming that VnB, VnA, VnE, and VnD are stored in the memories M1 through M4 of the neutral potential memory 192 as the neutral point potentials Vn1 through Vn4.

The subtractor 6c subtracts VnD in the memory M4 from VnA in the memory M2. And this differential value is inputted to the α-β converter 193b as VnU (=VnA-VnD). Moreover, the subtractor 6d subtracts VnE in the memory M3 from VnB in the memory M1. And, after the sign of this differential value has been inverted by the sign inversion gain 195, the result is inputted to the α-β converter 193b as VnV(=VnE−VnB). In other words while, with the initial position estimator 19B of FIG. 11 described above, VnU=VnA and VnV=−VnB, by contrast the feature by which this initial position estimator 19D differs from the initial position estimator 19B is that VnU=VnA−VnD and VnV=VnE−VnB.

The neutral point potentials VnB and VnE are neutral point potentials that are obtained by applying the voltage vectors in opposite directions, and changes in the two of them are fundamentally in opposite phases. The same holds for the neutral point potentials VnA and VnD. The way in which the neutral point potentials VnB, VnE, VnA, and VnD change is as shown in FIG. 10(a) and FIG. 10(b).

When the differentials VnU and VnV described above are α-β converted into Xα and Xβ by the α-β converter 193b, the resulting Xα and Xβ have the waveforms shown in FIG. 15(a). As will be understood from comparison of FIG. 15(a) and FIG. 12(b), the distortion components included in these waveforms are greatly reduced, and components of two cycles with respect to one full cycle of the electrical angle appear prominently. And the phase θds0 that is obtained by performing calculation by the arc tangent calculator 194b using Xα and Xβ and by processing by the half gain 196 has the waveform shown in FIG. 15(b). When FIG. 15(b) and FIG. 12(c) are compared together, it will be understood that the position estimation error is greatly improved, in particular in the vicinity of 180° and in the vicinity of 360° in the regions surrounded by the broken lines.

According to the fourth embodiment of the present invention shown in FIG. 15, it becomes possible greatly to improve the accuracy of position estimation by calculating the differential between the neutral point potentials VnB and VnE detected for the switching vectors V(1,1,0) and V(0,0,1) that are oriented in mutually opposite orientations and the differential between the neutral point potentials VnA and VnD detected for the switching vectors V(1,0,0) and V(0,1,1) that are similarly oriented in mutually opposite orientations, and by calculating the estimated phase angle θds0 over the range of a half cycle of electrical angle on the basis of these two differentials. And it is possible to estimate the rotor position over the full range of one electrical angle cycle at high accuracy by using the result of polarity determination together with this estimated phase angle θds0.

### Fifth Embodiment

Next, a fifth embodiment of the present invention will be explained. This fifth embodiment relates to a drive control device that is capable of initial position estimation in a situation such as, when, due to a load or the like, the rotor of the motor 4 is rotated, so that the rotor is rotating during motor starting (i.e. when its rotation is started). For example, consider a state in which a load pump or the like is connected to the motor, and the motor is rotated from the pump side, this being opposite to the normal situation. According to this fifth embodiment, even in a case of this sort, it is possible to estimate the rotor position at high accuracy.

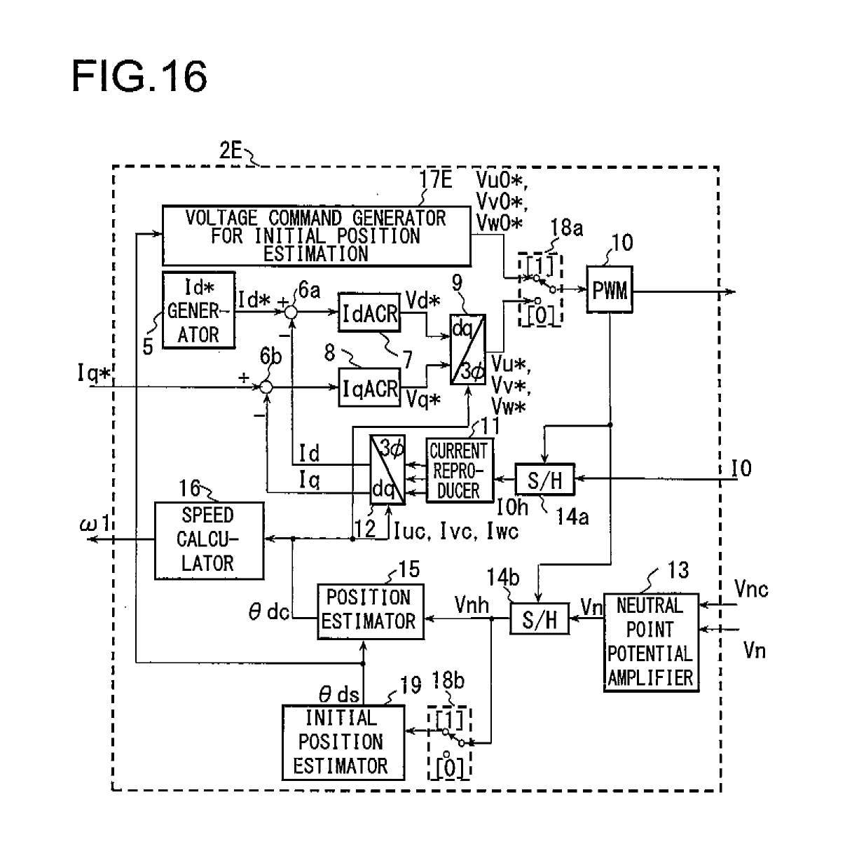

FIG. 16 is a block diagram of a controller 2E, which is the characteristic portion of this fifth embodiment. The drive control device 100 of the fifth embodiment is obtained by using this controller 2E instead of the controller 2 described above and shown in FIG. 1. In FIG. 16, a voltage command generator 17E for initial position estimation is the characteristic portion, and the other structures are the same as in the case of the controller 2 shown in FIG. 1.

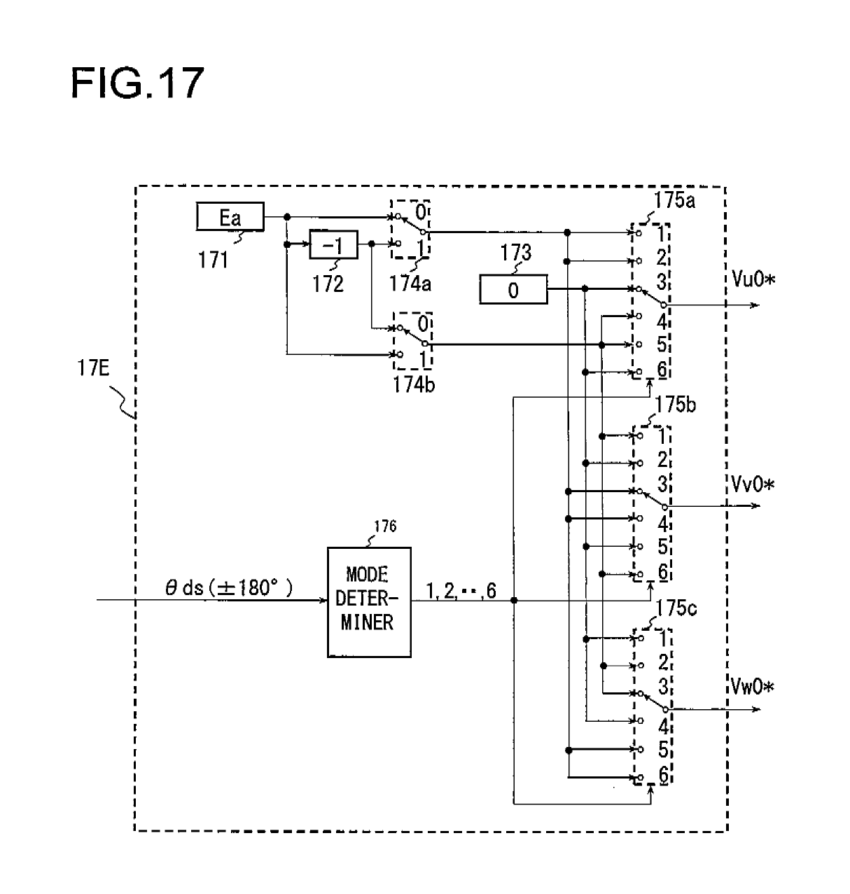

FIG. 17 is a figure showing the structure of the voltage command generator 17E for initial position estimation. As shown in FIG. 17, the voltage command generator 17E for initial position estimation comprises a minute voltage generator 171, a sign inverter 172, carrier synchronization changeover switches 174a and 174b, a zero generator 173, and command voltage changeover devices 175a through 175c.

Next, the operation of this voltage command generator 17E for initial position estimation will be explained. In a similar manner to the voltage command generator 17 for initial position estimation, the voltage command generator 17E for initial position estimation is a device that generates a voltage command for performing estimation of the position of the rotor when the motor is started, and, for initial position estimation, the initial position estimation changeover switches 18a and 18b are changed over to their “1” sides. The feature by which the voltage command generator 17E for initial position estimation differs from the voltage command generator 17 for initial position estimation shown in FIG. 1 is that the voltage command itself varies according to the result of position estimation.

In FIG. 17, switches of the command voltage changeover devices 175a through 175c that output the three-phase voltage commands Vu0*, Vv0*, and Vw0* are changed over according to a command from a mode determiner 176. On the basis of the result θds of position estimation inputted from the initial position estimator 19, the mode determiner 176 determines in which of the plurality of voltage vector regions (A1) through (A6) shown in FIG. 2 (i.e. in which of the modes 1 through 6) θds is present. And, during initial position estimation, the minute voltage generator 171 outputs a minute voltage Ea to be applied to the motor 4.

This minute voltage Ea is inputted to the “0” side of the carrier synchronization changeover switch 174a and to the “1” side of the carrier synchronization changeover switch 174b. Moreover, the minute voltage Ea outputted from the minute voltage generator 171 is inputted to the sign inverter 172, and the voltage −Ea that is obtained by sign inversion by the sign inverter 172 is inputted to the “1” side of the carrier synchronization changeover switch 174a and to the “0” side of the carrier synchronization changeover switch 174b.

The carrier synchronization changeover switches 174a and 174b are switches that are changed over in synchrony with the rising and falling of the triangular wave carrier shown in FIG. 8, and during the rising of the triangular wave carrier they are changed over to their “0” sides, while during the falling of the triangular wave carrier they are changed over to their “1” sides. In other words, during the rising of the triangular wave carrier, the minute voltage Ea is outputted from the carrier synchronization changeover switch 174a, while the minute voltage −Ea is outputted from the carrier synchronization changeover switch 174b. Conversely, during the falling of the triangular wave carrier, the minute voltage −Ea is outputted from the carrier synchronization changeover switch 174a, while the minute voltage Ea is outputted from the carrier synchronization changeover switch 174b.

Each of the command voltage changeover devices 175a through 175c comprises five input units and one output unit. The output side of the carrier synchronization changeover switch 174a is connected to the first input unit and to the second input unit of the command voltage changeover device 175a, to the third input unit and to the fourth input unit of the command voltage changeover device 175b, and to the fifth input unit and to the sixth input unit of the command voltage changeover device 175c. On the other hand, the output side of the carrier synchronization changeover switch 174b is connected to the fourth input unit and to the fifth input unit of the command voltage changeover device 175a, to the first input unit and to the sixth input unit of the command voltage changeover device 175b, and to the second input unit and to the third input unit of the command voltage changeover device 175c. Moreover, the zero generator 173 is connected to the third input unit and to the sixth input unit of the command voltage changeover device 175a, to the second input unit and to the fifth input unit of the command voltage changeover device 175b, and to the first input unit and to the fourth input unit of the command voltage changeover device 175c.

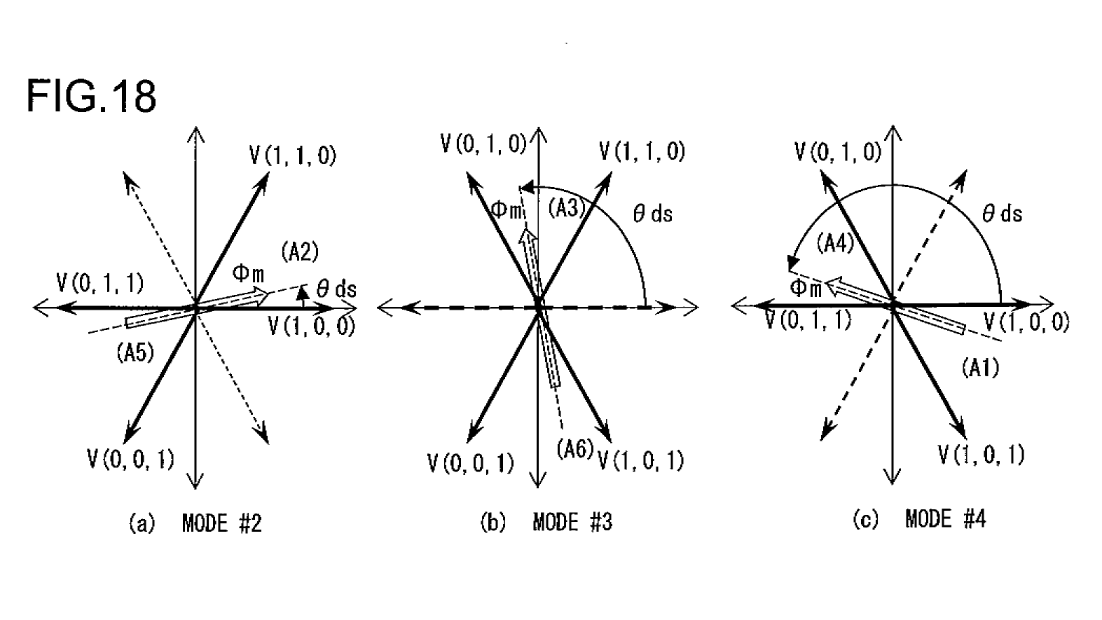

With the drive control device 100 of this embodiment, output of the three-phase voltage commands Vu0*, Vv0*, and Vw0* for initial position estimation from the voltage command generator 17E for initial position estimation is started at the starting of operation to start the motor; but, in the first estimation of the rotor position, the three-phase voltage commands Vu0*, Vv0*, and Vw0* are outputted without any relationship to the actual position of the rotor. In this case, a signal for any one of the modes 1 through 6 is outputted from the mode determiner 176. And, on the basis of these three-phase voltage commands, four voltage vectors are selected and calculation of the estimated phase angle is performed. However, once the estimated phase angle θds is obtained, this obtained θds is inputted to the mode determiner 176, and three-phase voltage commands Vu0*, Vv0*, and Vw0* are outputted from the voltage command generator 17E for initial position estimation, in other words voltage vectors to be applied are determined, corresponding to this θds. An example of this operation will now be explained with reference to FIG. 18.

If, as shown in FIG. 18(a), the estimated phase angle θds that has been calculated is in the range of 0° to 60° (in other words, in the case of mode 2), when this θds is inputted to the mode determiner 176, the mode determiner 176 determines that this is mode 2, and inputs this decision result to the command voltage changeover devices 175a through 175c. When this decision result of mode 2 is inputted, the command voltage changeover devices 175a through 175c output the minute voltages inputted to the second input unit corresponding to mode 2. It should be understood that the first input unit, the third input unit, the fourth input unit, the fifth input unit, and the sixth input unit respectively correspond to mode 1, mode 3, mode 4, mode 5, and mode 6.

In this case, the carrier synchronization changeover switches 174a and 174b are changed over to their “0” sides at the rising timing of the triangular wave carrier, so that the command voltage changeover device 175a outputs the voltage Ea as the voltage command Vu0*, the command voltage changeover device 175b outputs the zero voltage 0 as the voltage command Vv0*, and the command voltage changeover device 175c outputs the voltage −Ea as the voltage command Vw0*. As a result, the voltage vectors V(1,1,0) and V(1,0,0) on the two sides of mode 2 are selected, and the neutral point potentials VnB and VnA are detected.

On the other hand, at the falling timing of the triangular wave carrier, the carrier synchronization changeover switches 174a and 174b are changed over to their “1” sides, so that the command voltage changeover device 175a outputs the voltage −Ea as the voltage command Vu0*, the command voltage changeover device 175b outputs the zero voltage 0 as the voltage command Vv0*, and the command voltage changeover device 175c outputs the voltage Ea as the voltage command Vw0*. As a result, the voltage vectors V(0,0,1) and V(0,1,1) on the two sides of mode 5 are selected, and the neutral point potentials VnE and VnD are detected.

Furthermore, if the estimated phase angle θds is in mode 3 as shown in FIG. 18(b), then, at the rising timing of the triangular wave carrier, the command voltage changeover device 175a outputs the zero voltage 0 as the voltage command Vu0*, the command voltage changeover device 175b outputs the voltage Ea as the voltage command Vv0*, and the command voltage changeover device 175c outputs the voltage −Ea as the voltage command Vw0*. As a result, the voltage vectors V(1,1,0) and V(0,1,0) on the two sides of mode 3 are selected, and the neutral point potentials VnB and VnC are detected.

On the other hand, at the falling timing of the triangular wave carrier, the command voltage changeover device 175a outputs the zero voltage 0 as the voltage command Vu0*, the command voltage changeover device 175b outputs the voltage −Ea as the voltage command Vv0*, and the command voltage changeover device 175c outputs the voltage Ea as the voltage command Vw0*. As a result, the voltage vectors V(0,0,1) and V(1,0,1) on the two sides of mode 6 are selected, and the neutral point potentials VnE and VnF are detected.

Yet further, if the estimated phase angle θds is in mode 4 as shown in FIG. 18(c), then, at the rising timing of the triangular wave carrier, the command voltage changeover device 175a outputs the voltage −Ea as the voltage command Vu0*, the command voltage changeover device 175b outputs the voltage Ea as the voltage command Vv0*, and the command voltage changeover device 175c outputs the zero voltage 0 as the voltage command Vw0*. As a result, the voltage vectors V(0,1,1) and V(0,1,0) on the two sides of mode 4 are selected, and the neutral point potentials VnD and VnC are detected.

On the other hand, at the falling timing of the triangular wave carrier, the command voltage changeover device 175a outputs the voltage Ea as the voltage command Vu0*, the command voltage changeover device 175b outputs the voltage −Ea as the voltage command Vv0*, and the command voltage changeover device 175c outputs the zero voltage 0 as the voltage command Vw0*. As a result, the voltage vectors V(1,0,0) and V(1,0,1) on the two sides of mode 1 are selected, and the neutral point potentials VnA and VnF are detected.

In other words, as shown in FIG. 18, selection of the voltage vectors is performed so that the rotor position is always between them, even if, in the state before the motor actually rotates (in other words, before the motor starts), the rotor is rotated due to some load fluctuation and the position of the rotor changes. This way of selecting the voltage vectors makes it possible, during calculation of the estimated position of the rotor, to perform position estimation at the highest sensitivity and accuracy.

For example, if the rotor is in the state of mode 2, then the voltage vectors selected as described above are the four vectors V(1,0,0), V(1,1,0), V(0,1,1), and V(0,0,1), and the respective neutral point potentials VnA, VnB, VnD, and VnE are detected. And it is understood that the phase conditions under which these four neutral point potentials are detected at the highest sensitivity is in the vicinity of θd=0° to 60° and in the vicinity of θd=180° to 240°, as shown in FIG. 10(a) through FIG. 10(c). The fact that the sensitivity is high means that the accuracy of position determination is high, and also that there can be few causes for error during polarity determination.

Since with this fifth embodiment, as described above, it is arranged to generate the voltage commands Vu0*, Vv0*, and Vw0* so as to obtain the four voltage vectors on either side of the magnetic flux vector Φ of the rotor in the positive direction and in the negative direction on the basis of the value θds estimated by the initial position estimator 19, accordingly, even if the rotor moves due to fluctuation of the load or the like before starting of the three-phase synchronous motor (i.e. before starting of rotation thereof), still it is possible always to maintain position estimation at high accuracy.

### Sixth Embodiment

Next, a sixth embodiment of the present invention will be explained. This sixth embodiment relates to estimation of the rotor position when, after actual operation of the motor has started, no command is generated from a higher level (for example from a control device on a vehicle), so that the waiting state is maintained.

For example, in the case of an electrically driven power steering of an automobile or the like, even though actual operation has started, provided that steering does not require any torque to be generated, no torque command is generated from a higher level (in FIG. 1, this would be a command outputted by the Iq* generator). However, even in this type of case, it is necessary to continue estimation of the position of the rotor. In particular, in order to be able to respond immediately if a torque command is provided, it is necessary always to estimate the rotor position.

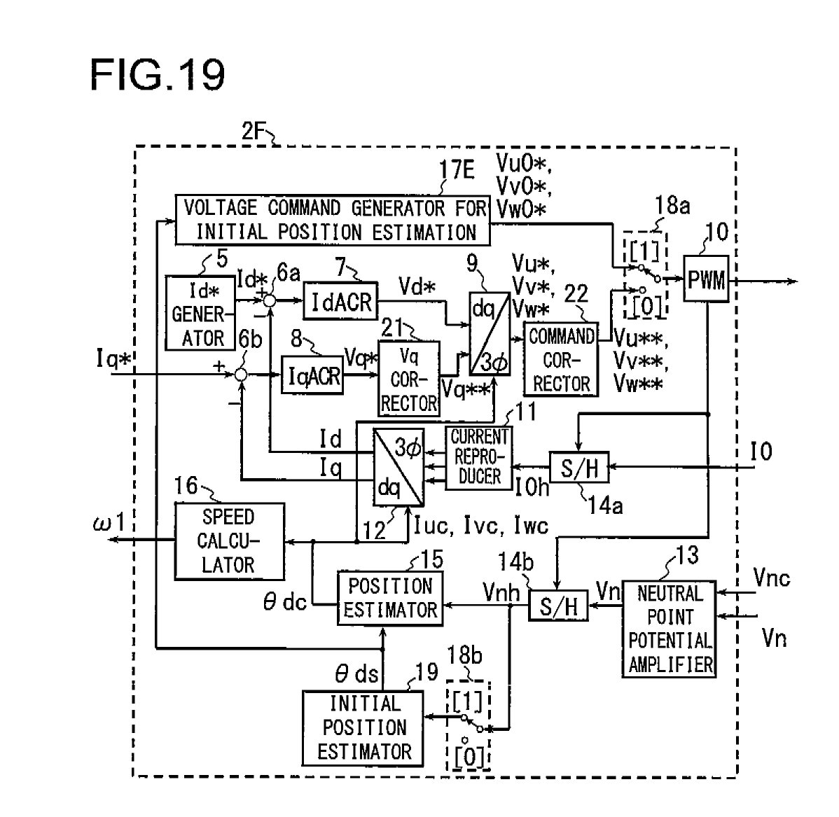

FIG. 19 is a block diagram of a controller 2F, which is the characteristic portion of this sixth embodiment. The drive control device 100 of the sixth embodiment is constructed by using this controller 2F instead of the controller 2 of FIG. 1. In FIG. 19, a Vq corrector 21 and a three-phase corrector 22 are the characteristic portions of this embodiment, and the other structures are the same as in the case of the controller 2E of the fifth embodiment shown in FIG. 16.

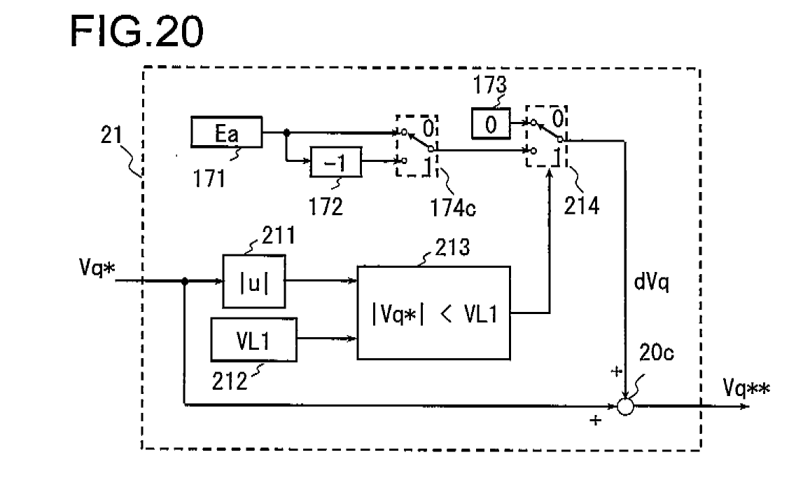

FIG. 20 is a figure showing the structure of the Vq corrector 21. This Vq corrector 21 comprises the minute voltage generator 171, the sign inverter 172, the zero generator 173, a carrier synchronization changeover switch 174c, an absolute value calculator 211, a VL1 generator 212, a comparator 213, a minute change addition changeover switch 214, and an adder 20c.

The minute voltage generator 171, the sign inverter 172, and the zero generator 173 are the same as those provided to the voltage command generator 17E for initial position estimation shown in FIG. 17. Moreover, the carrier synchronization changeover switch 174c also is a switch that operates in the same manner as the carrier synchronization changeover switches 174a and 174b shown in the voltage command generator 17E for initial position estimation. The absolute value calculator 211 calculates the absolute value of the voltage command Vq*. And the VL1 generator 212 generates a comparison level for the magnitude of the voltage command Vq*. The comparator 213 compares together the magnitudes of the signals inputted from the absolute value calculator 211 and from the VL1 generator 212, and changes over the minute change addition changeover switch 214 on the basis of the result of this comparison.

Next, the operation of the Vq corrector 21 will be explained. The Vq corrector 21 of this embodiment is a device that adds a minute signal for forcibly performing position estimation to the q axis voltage command, if during actual operation the absolute value of the command value is lower than the predetermined level (VL1). First, the absolute value of the voltage command Vq* is calculated by the absolute value calculator 211, and then the result of this calculation and the predetermined value VL1 that is outputted from the VL1 generator 212 as a comparison level are compared together by the comparator 213.

If the magnitude (in absolute value) of the voltage command Vq* is smaller than the predetermined value VL1, then the comparator 213 changes over the minute change addition changeover switch 214 to its “1” side. The signal from the zero generator 173 is inputted to the “0” side of the minute change addition changeover switch 214, and the signal from the carrier synchronization changeover switch 174c is inputted to its “1” side. In other words, the minute voltage Ea generated by the minute voltage generator 171 is inputted to the “1” side at the rising timing of the triangular wave carrier, while the minute voltage −Ea with its sign changed by the sign inverter 172 is inputted to the “1” side at the falling timing of the triangular wave carrier.

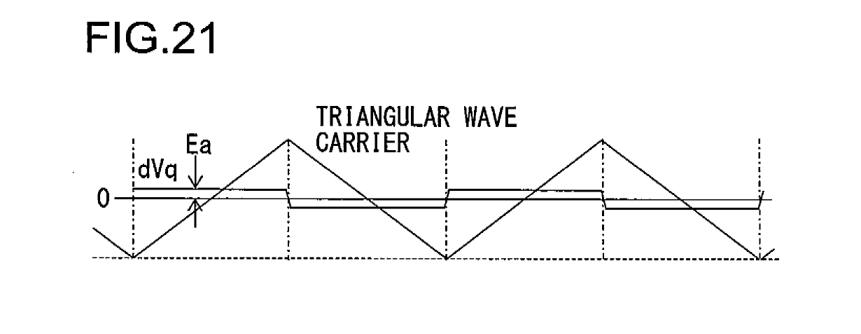

When the minute change addition changeover switch 214 is at its “0” side, then the signal (a zero voltage) from the zero generator 173 is inputted to the adder 20c as a signal dVq. On the other hand, when the minute change addition changeover switch 214 is at its “1” side, then the minute voltage Ea is inputted as the signal dVq at the rising timing of the triangular wave carrier, while the minute voltage −Ea is inputted as the signal dVq at the falling timing of the triangular wave carrier. FIG. 21 is a figure showing the waveform of the signal dVq when the minute change addition changeover switch 214 is at its “1” side. dVq=Ea on the rising of the triangular wave carrier, while dVq=−Ea on the falling of the triangular wave carrier.

The adder 20c is a component that adds the signal dVq outputted from the minute change addition changeover switch 214 to the voltage command Vq*, and that outputs the result of this addition as a signal Vq**. As a result, if the magnitude (i.e. the absolute value) of the voltage command Vq* is greater than or equal to the predetermined value VL1, then the voltage command Vq* that is inputted to the Vq corrector 21 is outputted as the signal Vq** just as it is without alteration. On the other hand, if the magnitude (the absolute value) of the voltage command Vq* is less than the predetermined value VL1, then the signal dVq is added to the voltage command Vq*, and the result is outputted as the signal Vq** (=Vq*+dVq).

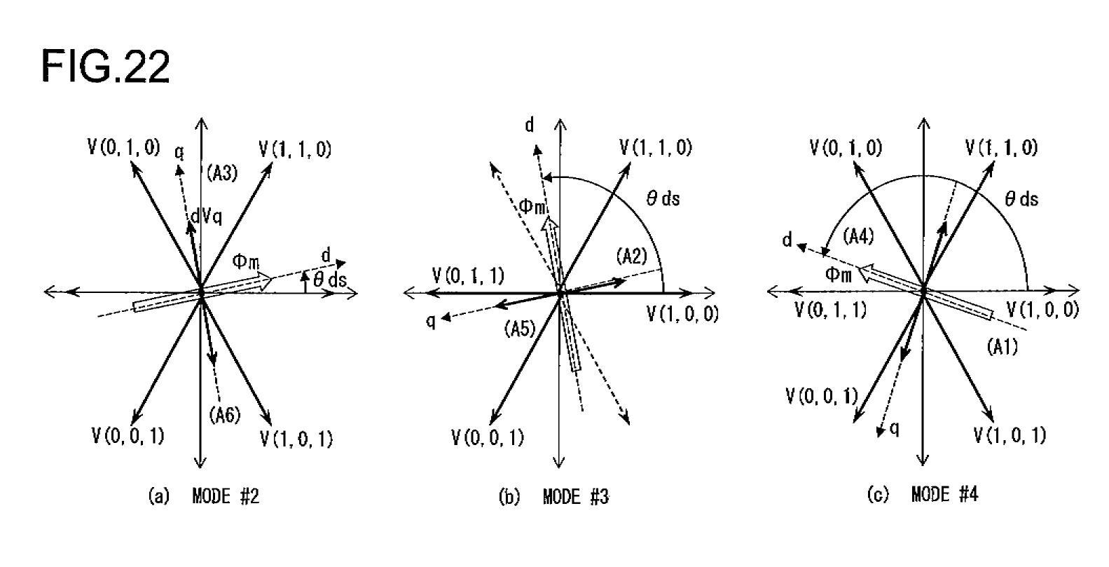

When the Vq** that has been generated in this manner is coordinate converted and PWM is implemented, the voltage vectors applied to the motor 4 becomes as shown in FIG. 22. In FIG. 22, (a) shows the case of mode 2, (b) shows the case of mode 3, and (c) shows the case of mode 4. Since the axis that is orthogonal to the phase of the rotor (i.e. the d axis) is the q axis, accordingly the voltage vectors that are selected are the vectors on either side of the q axis. This result is one that is 90° different from the case of the fifth embodiment shown in FIG. 18. However, during actual operation, it is necessary to give emphasis to responsiveness to torque commands, so that it is more convenient to continue applying that voltage vectors that are positioned so as always to be capable of generating torque, in other words the voltage vectors that enclose the q axis.

For example, if torque is requested in mode 2, then, according to this torque request, by stopping either the voltage vectors V(0,1,0) and V(1,1,0), or the voltage vectors V(0,0,1) and V(1,0,1), it is possible to quickly respond to this torque request.

It should be understood that, if the rotor position is to be estimated on the basis of four voltage vectors, then it will be acceptable to include the structure of the initial position estimator 19, 19B, 19C, or 19D shown in FIG. 9, 11, 13, or 14 in the interior of the position estimator 15, and to change over between this block and a block that performs estimation by using two voltage vectors so as to use one of them. Or it would be possible to change over the changeover device 18b to its “1” side, if four voltage vectors are to be used.

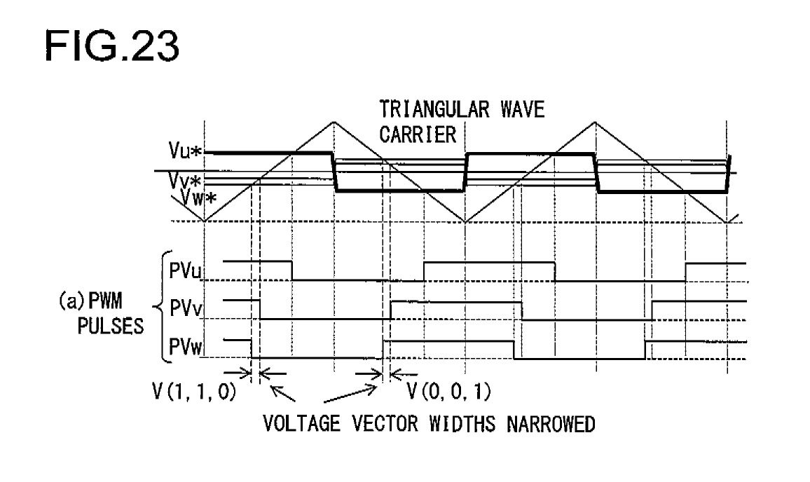

While theoretically the operation of FIG. 22 can be implemented with the Vq corrector 21 shown in FIG. 20, a problem arises in practice with the minimum pulse width. When Vq* is subjected to d-q inverse transformation into three-phase commands, in some cases the situation arises that, due to the phase conditions, the differences of Vu*, Vv*, and Vw* become small, so that a sufficiently long duration for detecting the neutral point potential cannot be obtained. FIG. 23 is a figure showing this case: in this figure, both the width (i.e. the duration) of the voltage vector V(1,1,0) and the width of the voltage vector V(0,0,1) that has the opposite orientation thereto are narrow.

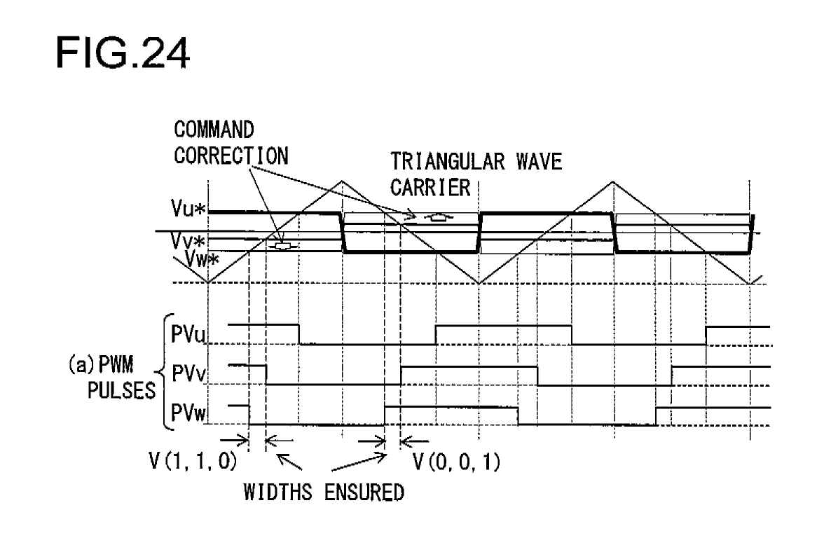

In this embodiment, in order to solve this type of problem, it is arranged for the three-phase corrector 22 to perform a correction upon the three-phase voltage commands. In concrete terms, a lower limit limiter may be provided so that the differences of each of the three phases do not become lower than a predetermined value that is set in advance. FIG. 24 is a figure in which Vw* of FIG. 23 has been corrected, so that the differences between Vv* and Vw* are widened by this correction, and it is possible to ensure the widths (i.e. the intervals) of the voltage vectors V(1,1,0) and V(0,0,1).

Since, as described above, in this sixth embodiment, in a case such as when the waiting state is sustained without any command being generated from a higher level, in other words if the magnitude of the voltage command Vq* for rotational torque is smaller than the predetermined value VL1, then it is arranged to correct the voltage command Vq* for rotational torque so that three-phase voltage commands are generated that select, as the four switching vectors, vectors in a relationship of being close to or adjacent to vectors that are orthogonal to the rotor magnetic flux vector, accordingly it is possible to provide a highly responsive three-phase synchronous motor that is capable of an immediate response, even if the command thereto changes suddenly during operation.

### Seventh Embodiment

Next, a seventh embodiment of the present invention will be explained. This seventh embodiment is one that relates to enhancement of the accuracy of position estimation during actual operation of the motor. For the voltage vectors during actual operation, normally, apart from the zero vectors, two different voltage vectors are employed (refer to FIG. 34). If the initial position estimation is performed reliably, then, fundamentally, estimation of the position of the rotor is possible by obtaining the neutral point potentials when voltage vectors of two types are applied. However, as has already been explained in connection with the fourth embodiment, the position estimation accuracy is better if voltage vectors of four types are employed. Accordingly, in this embodiment, it is arranged to enhance the accuracy of position detection by applying voltage vectors of four types, even during actual operation.

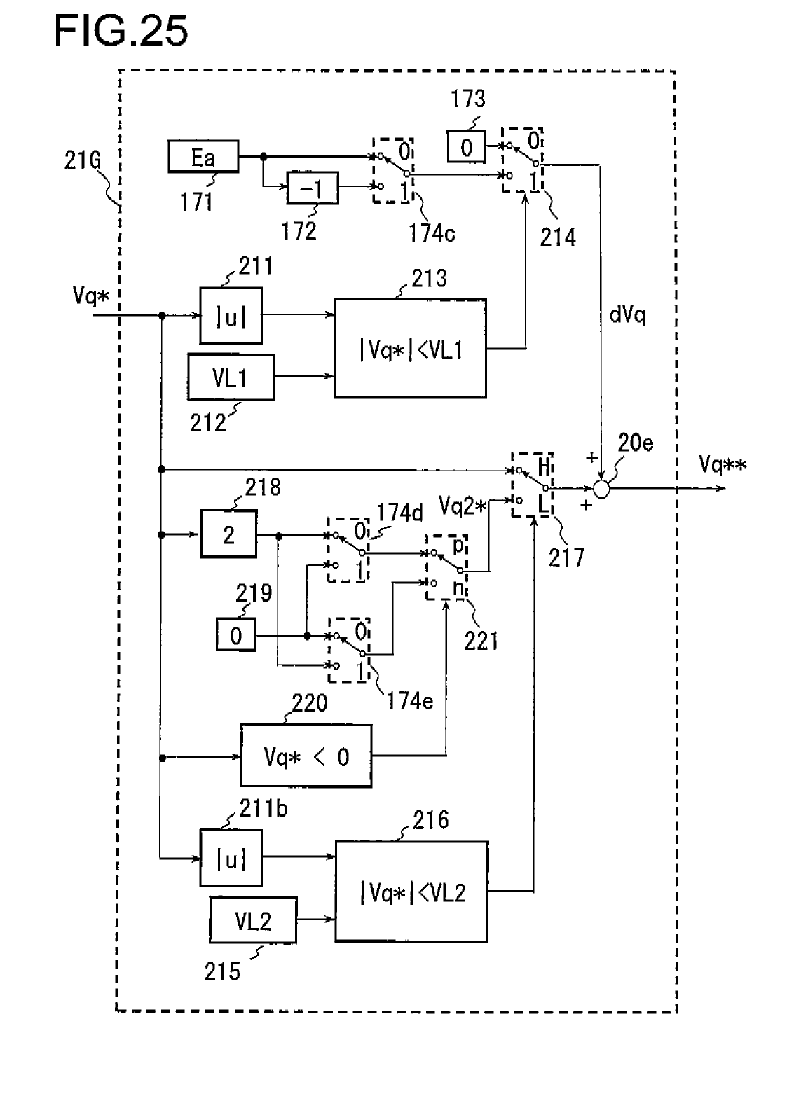

FIG. 25 is a block diagram of a Vq controller 21G, which is the characteristic portion of this seventh embodiment. The drive control device 100 of the seventh embodiment is constructed by using this controller 21G instead of the Vq controller 21 of FIG. 19.

The Vq corrector 21G comprises the minute voltage generator 171, the sign inverter 172, zero generators 173 and 219, carrier synchronization changeover switches 174c through 174e, absolute value calculators 211 and 211b, the VL1 generator 212, comparators 213, 216, and 220, the minute change addition changeover switch 214, a VL2 generator 215, a Vq command changeover switch 217, a double gain 218, a zero generator 219, a changeover device 221, and an adder 20e.

It should be understood that the minute voltage generator 171, the sign inverter 172, the zero generator 173, the carrier synchronization changeover switch 174c, the absolute value calculator 211, the VL1 generator 212, the comparator 213, the minute change addition changeover switch 214, and the adder 20c are components that are the same as those shown in FIG. 20. Moreover, the absolute value calculator 211b and the carrier synchronization changeover switches 174d and 174e are, respectively, components that operate in the same manner as the absolute value calculator 211 and the carrier synchronization changeover switch 174c.

Next, the operation of this embodiment will be explained. It should be understood that explanation of the operation to generate the signal dVq is omitted, since this operation is the same as in the sixth embodiment. When the Vq command changeover switch 217 is changed over to its “H” side, then a similar signal Vq** is outputted from the adder 20e as in the case of the sixth embodiment. In addition to the above operations, operation like the following is executed by the Vq corrector 21G.

First, the magnitude of the voltage command Vq* (i.e. its absolute value) is obtained by the absolute value calculator 211b. And the comparator 216 compares together the magnitude of this voltage command Vq* and the magnitude of a predetermined value VL2 that is a level that is set in advance. The predetermined value VL2 is outputted from the VL2 generator 215. It should be understood that the magnitude relationship with the predetermined value VL1 described above is set so that VL2<VL1. If the result of this comparison is that the magnitude of the voltage command Vq* is greater than or equal to the predetermined value VL2, in other words if the magnitude of the voltage applied to the motor 4 is sufficiently large (i.e. the rotational speed is in a somewhat high state), then the Vq command changeover switch 217 is changed over to its “H” side. On the other hand, if |Vq*|<VL2, in other words if the magnitude of the voltage applied to the motor 4 is small (i.e. if the rotational speed is low, in which case the possibility of reverse rotation due to load fluctuation or the like is high), then the Vq command changeover switch 217 is changed over to its “L” side. The voltage command Vq2* after correction is inputted to the Vq command changeover switch 217 at its “L” side. Thus, if the Vq command changeover switch 217 is at its “H” side, then the voltage command Vq* is outputted just as it is without alteration to the adder 20e, whereas, if the switch 217 is at its “L” side, then the voltage command Vq2* after correction is outputted.

The voltage command Vq2* after correction is set in the following manner. The comparator 220 compares whether or not the polarity of the voltage command Vq* is negative. And the changeover device 221 that inputs Vq2* to the “L” side of the Vq command changeover switch 217 is changed over to its “p” side if the polarity of the voltage command Vq* is “positive”, while, conversely, if the above polarity is “negative”, then the changeover device is changed over to its “n” side.

During the rising of the triangular wave carrier, the carrier synchronization changeover switches 174d and 174e are changed over to their “0” sides, while during falling of the triangular wave carrier they are changed over to their “1” sides. Due to this, during the rising of the triangular wave carrier, 2Vq*, i.e. Vq* doubled by the double gain 218, is inputted to the “p” side of the changeover device 221, while the zero signal outputted from the zero generator 219 is inputted to the “n” side of the changeover device 221. Conversely, during the falling of the triangular wave carrier, the zero signal of the zero generator 219 is inputted to the “p” side of the changeover device 221, while 2Vq* is inputted to the “n” side of the changeover device 221.

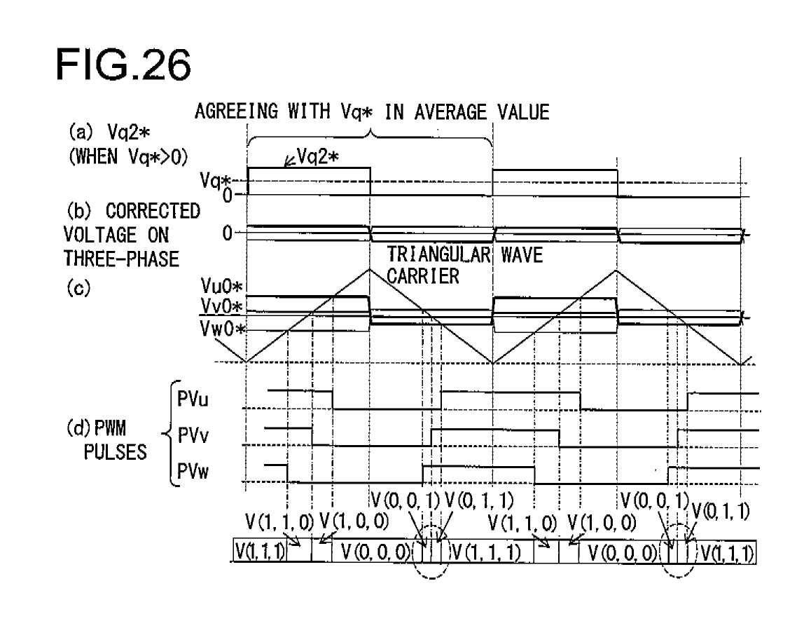

FIG. 26 shows the waveform when the voltage command Vq* is “positive”. In the case of Vq*>0 shown in FIG. 26(a), Vq* becomes doubled during the “rising” interval of the triangular wave carrier, while during the “falling” interval it become zero. Due to this, the voltage command itself agrees with the original Vq* when averaged over one complete cycle, and, when its average is considered, becomes a voltage command requesting a torque that is substantially the same as the original voltage command. By correcting the original voltage command Vq* to the voltage command Vq2* that, as shown in FIG. 26(a), becomes 2Vq* during the rising interval while it becomes 0 during the falling interval, the voltage vector in the falling interval becomes of opposite orientation to the voltage vector during the rising interval. In this case, as shown in FIG. 26(d), the output interval for the voltage vectors becomes longer during the rising interval of the triangular wave carrier, and conversely, during the falling interval of the triangular wave carrier, the voltage vectors of the opposite orientation are outputted only for a short time. In other words, the voltage vectors in the opposite direction are ensured, as shown in the ranges surrounded by the broken lines. In this manner, the voltage command itself agrees with the original Vq* when averaged over a full one cycle, and moreover it becomes possible to output four voltage vectors during a full one cycle of the carrier. As a result, it is possible to enhance the accuracy of phase detection.

It should be understood that, if the rotor position is to be estimated on the basis of four voltage vectors, then it will be acceptable to include the structure of the initial position estimator 19, 19B, 19C, or 19D shown in FIG. 9, 11, 13, or 14 in the interior of the position estimator 15, and to change over between this block and a block that performs estimation by using two voltage vectors so as to use one of them. Or it would also be possible to change over the changeover device 18b to its “1” side, if four voltage vectors are to be used.

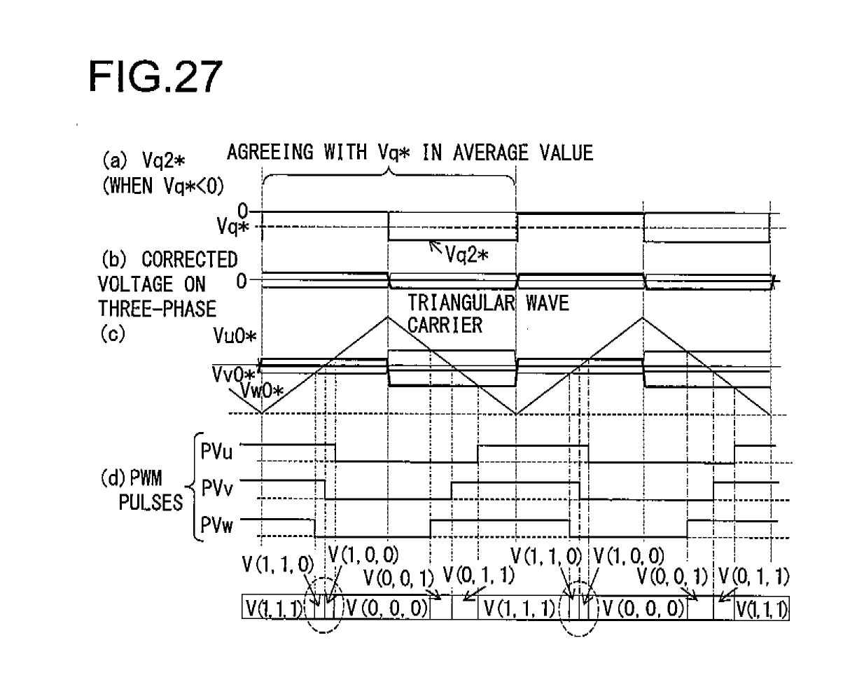

FIG. 27 shows the waveform when the voltage command Vq* is “negative”. In this case, in a similar manner to the case of FIG. 26, the voltage command itself agrees with the original Vq* when averaged over a full one cycle, and moreover it becomes possible to output four voltage vectors during a full one cycle of the carrier. In other words, the voltage vectors in the opposite direction are ensured, as shown in the ranges surrounded by the broken lines. It should be understood that, if Vq*<0, then the output interval becomes longer for the voltage vectors in the opposite direction, since it becomes 2Vq* during the falling interval of the triangular wave carrier.

As described above, in this embodiment, if the magnitude of Vq* is smaller than the predetermined value VL2, in other words if the voltage applied to the motor is low (the rotational speed is low) and it is easy for the influence of rotational fluctuations to be experienced, then the Vq command changeover switch 217 is changed over to its “L” side and four voltage vectors are applied, so that estimation of the rotor position (i.e. of its phase) is performed using four neutral point potentials. Due to this, it is possible to apply voltage vectors of four types during the operation of the three-phase synchronous motor as well, so that it becomes possible greatly to enhance the accuracy of position detection.

### Eighth Embodiment

Next, an eighth embodiment of the present invention will be explained. This eighth embodiment is one that relates to the method for changeover of the method for position estimation during actual operation of the motor. While it is possible to apply the method of estimating the rotor position by using the neutral point potentials without any dependence upon the rotational speed, it is necessary to ensure the necessary PWM pulse width for reliably detecting the neutral point potentials. Furthermore while, as described above, the accuracy of estimation is enhanced when voltage vectors of four types are applied as compared to the case when voltage vectors of two types are applied, when an attempt is made to maximize the voltage applied to the motor, it is not possible to continue application of four vectors because the voltage that can be applied drops (i.e., since the voltage applied to the motor is generated in combination with the voltage vector of opposite orientation, accordingly the total applied voltage inevitably but undesirably becomes lower). In other words a high voltage has to be applied when driving the motor 4 at high speed, since there is an influence from the counterelectromotive voltage generated by the motor. As a result, it becomes impossible to apply voltage vectors of four types.

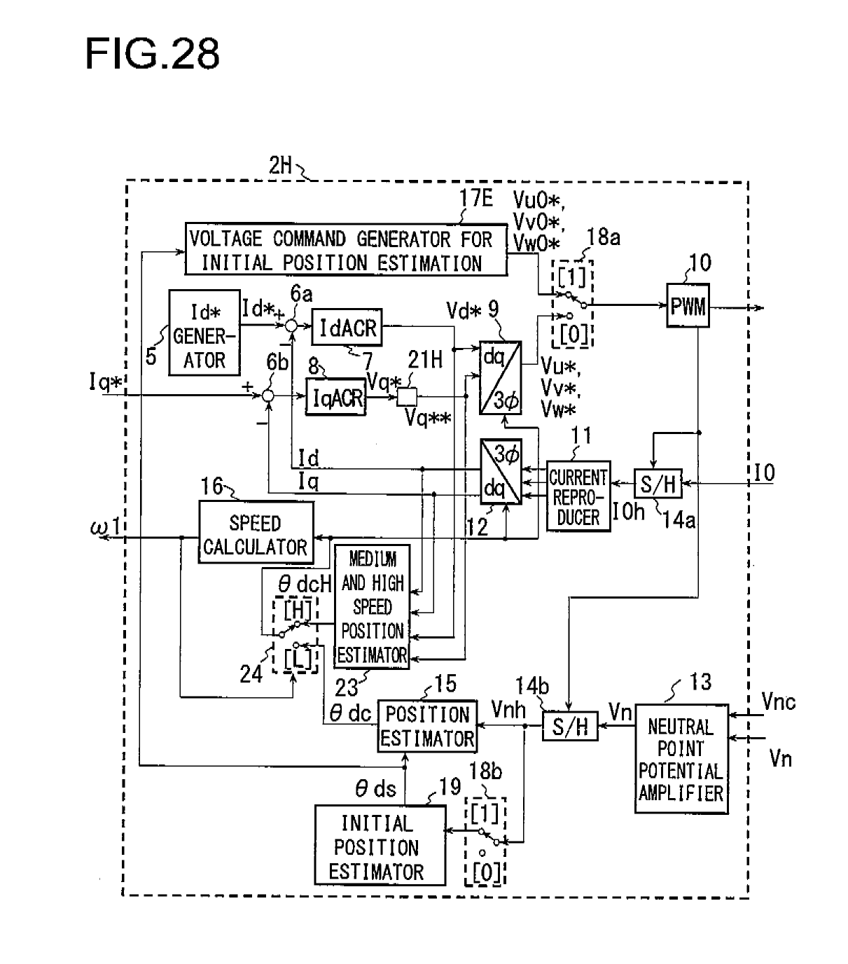

Thus, in this embodiment, in the high rotational speed region, it is arranged to change over to the “method of using the induced voltage” as used conventionally. The structure of a controller 2H of this embodiment is shown in FIG. 28. The drive control device 100 of the eighth embodiment is constructed by using this controller 2H instead of the controller 2 of FIG. 1.

The structure of the controller 2H shown in FIG. 28 is obtained by adding a Vq corrector 21H, a medium and high speed position estimator 23, and an estimated value changeover device 24 to the controller 2E shown in FIG. 16. As will be described hereinafter, in this eighth embodiment, it is arranged to change over between the case in which four voltage vectors are applied and the case when two voltage vectors are applied as in the conventional devices, according to the rotational speed ω1 of the motor 4. On the basis of the voltage commands Vd* and Vq* and also the detected currents Id and Iq, the medium and high speed position estimator 23 performs calculation to estimate the counterelectromotive voltage of the motor 4, and calculates the rotor phase θdch from the phase of this counterelectromotive voltage. In other words, by using the medium and high speed position estimator 23, it is possible to estimate the rotor phase without using any of the neutral point potentials at all. It should be understood that, since this method of calculating the rotor phase by employing the counterelectromotive voltage is a per se known technique (for example, refer to Japanese Laid-Open Patent Publication No. 2001-251889), accordingly explanation thereof will herein be omitted.

Whether or not the medium and high speed position estimator 23 is to be used is determined by the estimated value changeover device 24. When the motor 4 is started, the estimated value changeover device 24 is set to its “L” side. Due to this, when the motor 4 starts to rotate, the speed calculator 16 uses the phase θdc outputted from the position estimator 15 and based upon the neutral point potentials in its calculation of the estimated speed ω1. Thereafter, when the rotational speed of the motor 4 becomes high and the estimated speed ω1 inputted from the speed calculator 16 becomes greater than or equal to a speed ωth that is set in advance, the estimated value changeover device 24 is changed over to its “H” side. As a result, θdcH, which is the result of calculation by the medium and high speed position estimator 23, is inputted to the speed calculator 16.

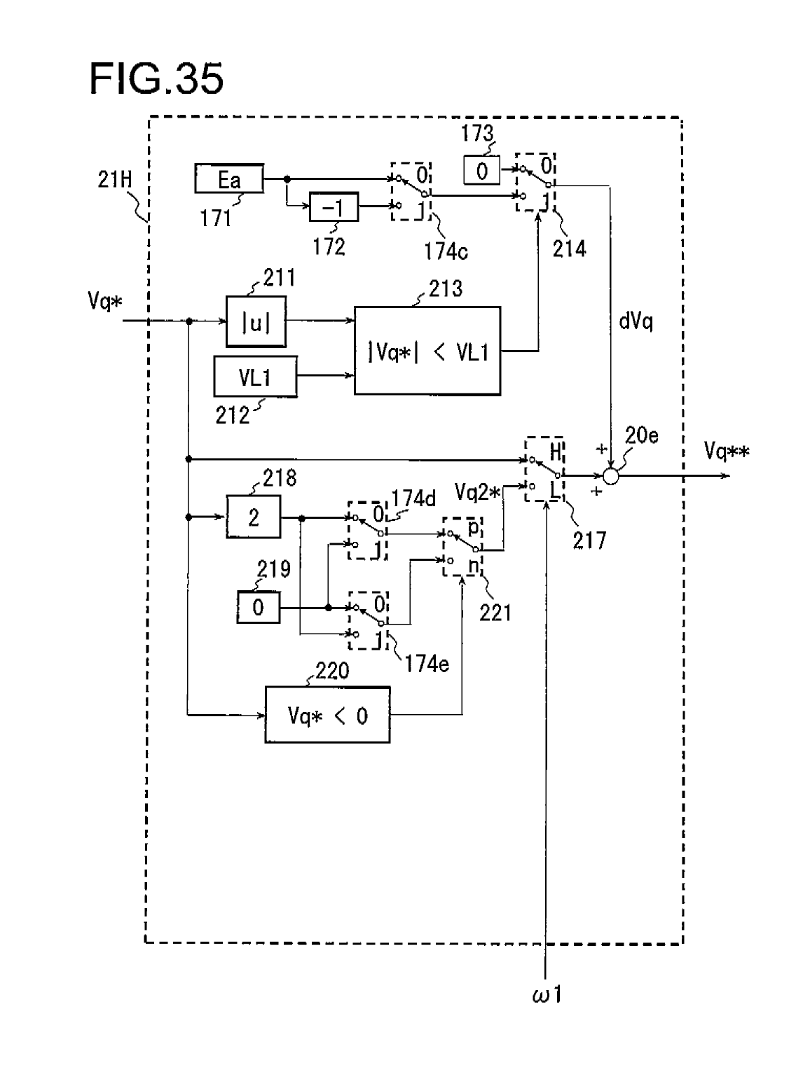

Moreover, the estimated speed ω1 from the speed calculator 16 is also inputted to the Vq corrector 21H, and, if ω1≧ωth, then the system changes from the state in which four voltage vectors are applied to the state in which two voltage vectors are applied, as in the conventional devices. FIG. 35 is a block diagram of the Vq corrector 21H in this eighth embodiment. This Vq corrector 21H is a device in which the absolute value calculator 211b, the VL2 generator 215, and the comparator 216 in the Vq corrector 21G shown in FIG. 25 have been eliminated. Moreover, the estimated speed ω1 from the speed calculator 16 is inputted to the Vq command changeover switch 217. If the estimated speed ω1 that has been inputted is greater than or equal to the speed ωth, then the Vq command changeover switch 217 is changed over to its “H” side, and Vq* is inputted to the adder 20e. In other words, two voltage vectors are applied, as in the prior art. On the other hand, if the estimated speed ω1 is less than the speed ωth, then the switch 217 is changed over to its “L” side, and four voltage vectors come to be applied, as shown in FIG. 26.

As described above, according to the eighth embodiment of the present invention, it becomes possible to implement an ideal three-phase synchronous motor over a broad range, from the low speed region including zero to the high speed region.

It should be understood that while, in the example described above, it is arranged to perform changeover according to whether or not the estimated speed ω1 is greater than or equal to the speed ωth, it would also be acceptable to arrange to perform changeover according to whether or not the output voltage of the three-phase inverter 3 is greater than or equal to a predetermined value (i.e. a voltage corresponding to ωth described above). It should also be understood that the voltage outputted by the three-phase inverter 3 may be estimated from the three-phase voltage commands that are outputted from the d-q inverse converter 9.

### Ninth Embodiment

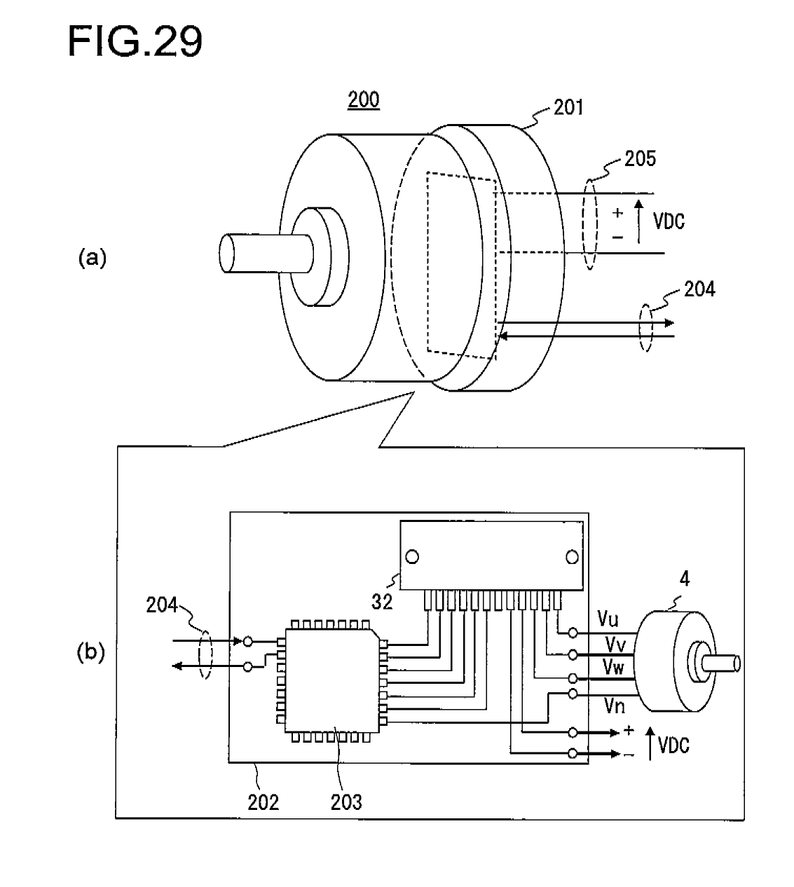

Next, a ninth embodiment of the present invention will be explained. FIG. 29 is a figure showing an integrated type three-phase synchronous motor 200 in which the drive control device 100 according to one of the first through the eighth embodiments described above and the motor 4 are provided integrally with one another. FIG. 29(a) is an external perspective view showing this integrated type three-phase synchronous motor 200, while FIG. 29(b) is a figure showing the structure of the integrated type three-phase synchronous motor 200. This integrated type three-phase synchronous motor 200 is one in which the motor 4 and the drive control unit 100 described above are provided as integrated within a casing 201. The casing 201 may also serve as a case for the motor 4; or a motor case and the casing 201 may be provided separately.

As shown in FIG. 29(b), the Iq* generator 1 and the controller 2 shown in FIG. 1 are implemented as a single integrated circuit 203, and the inverter 3 is driven by the PWM pulse waveforms outputted from this circuit. The inverter 3 and the integrated circuit 203 are implemented upon a board 202, and wiring for supplying the U, V, and W phase currents and wiring for detecting the neutral point potentials Vn are provided between the board 202 and the motor 4. These wiring systems are housed in the casing 201 by integrating the components in this manner. Due to this, the only wiring that extends to the exterior from the casing 201 is a power supply line 205 to the inverter 3 and a communication line 204 that is used for the rotational speed command and for returning the operational state and so on.

Furthermore, while in the case of the first through the eighth embodiments described above it is necessary to bring out the neutral point potential Vn of the motor 4, the wiring for the neutral point potential becomes simple and easy by integrating the motor and the drive circuitry portion in this manner. Yet further, since it is possible to implement sensor-less positioning, accordingly it is possible to provide an integrated system that is extremely compact overall, and it is possible to implement the system in a more compact manner.

### Tenth Embodiment

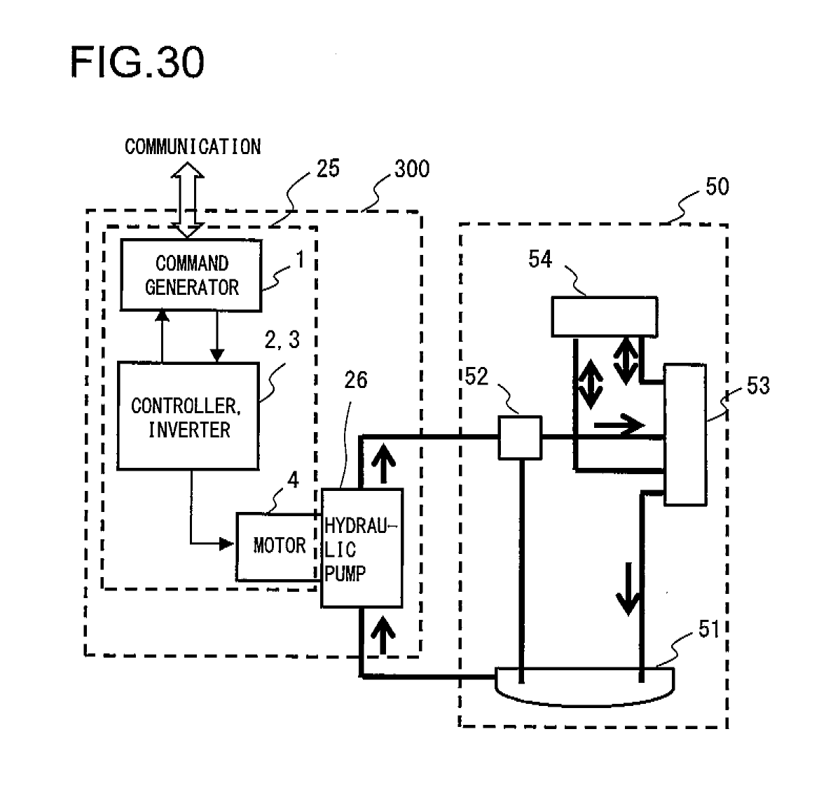

Next, a tenth embodiment of the present invention will be explained. This tenth embodiment relates to a pump device 300, and is an apparatus in which a hydraulic pump 26 is driven by the permanent magnet motor (a three-phase synchronous motor) 4 that is driven and controlled by the drive control device 100 as described in one of the first through the eighth embodiments. It should be understood that, while in FIG. 30 the pump device is constructed using the integrated type three-phase synchronous motor 200 shown in the ninth embodiment, it would also be acceptable for the drive control device 100 and the motor 4 to be provided separately.

The pump device 300 shown in FIG. 30 is a hydraulic drive system that includes the hydraulic pump 26, and controls the hydraulic pressure in a hydraulic circuit 50 that is used in an automobile for transmission hydraulic pressure or brake hydraulic pressure or the like with the hydraulic pump 26. The hydraulic circuit 50 comprises a tank 51 that stores hydraulic oil, a relief valve 52 that keeps the hydraulic pressure less than or equal to a set value, a solenoid valve 53 that changes over the hydraulic circuit, and a cylinder 54 that functions as a hydraulic actuator.

When the hydraulic pump 26 is rotationally driven by the motor 4, hydraulic pressure is generated by the hydraulic pump 26, and the cylinder 54, which is a hydraulic actuator, is driven by this hydraulic pressure. In this hydraulic circuit 50, the load upon the hydraulic pump 26 changes each time the circuit is changed by the solenoid valve 53, and a disturbance to the load on the motor 4 is created. Moreover, sometimes a load is imposed upon the hydraulic circuit that is several times or more that of the pressure in the stationary state, and in some cases the motor stops, which is undesirable.

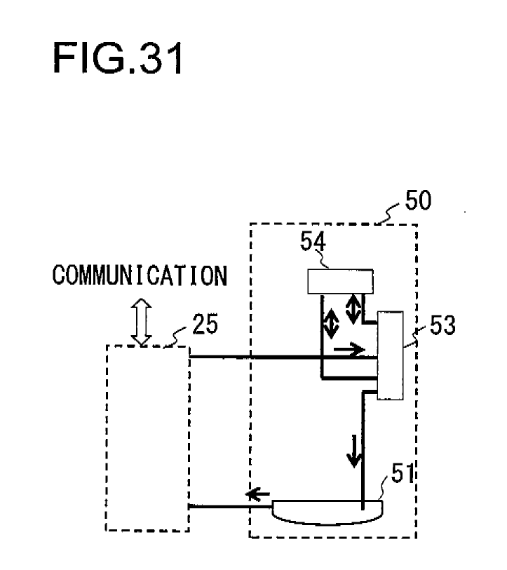

However, no problem arises with the pump device according to this embodiment, since it is possible to estimate the rotor position even with the motor in the stopped state. Moreover since, with conventional sensor-less motors, application has been difficult except in the medium and high speed region and higher, accordingly it has been essential to relieve the hydraulic pressure with the relief valve 52 when the load upon the motor becomes very great. However, according to this embodiment, it is also possible to eliminate the relief valve 52, as shown in FIG. 31. In other words, it becomes possible to perform hydraulic control without providing any relief valve to serve as a mechanical protection device for relieving excessively great load upon the motor.

### Eleventh Embodiment

Next, an eleventh embodiment of the present invention will be explained. This eleventh embodiment relates to a compressor drive system, in which a compressor is driven by the motor 4 that is driven and controlled by the drive control device 100 as described in one of the first through the eighth embodiments.

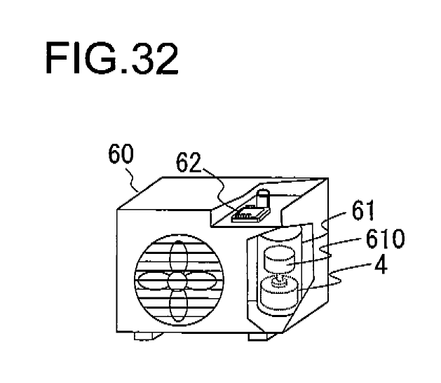

FIG. 32 is a figure showing an outdoor unit 60 of an air conditioning system comprising a compressor drive system according to this embodiment. This type of outdoor unit 60 is used with an air conditioning system like a room air conditioner or a package air conditioner. The compressor drive system that is provided to the outdoor unit 60 comprises an internal motor type compressor 61 and a control unit 62 that drives and controls this compressor. A compressor main body 610 and the motor 4 that is the power source for this compressor main body 610 are housed in the interior of the compressor 61. Moreover, the drive control device 100 and the inverter 3 described above are provided to this control unit 62.

Enhancement of the efficiency of air conditioning systems is proceeding from year to year, and it is necessary to achieve energy saving in the stationary state and during driving at ultra low speed. However, since conventional sensor-less driving has been limited to the medium and high speed regions, accordingly driving at ultra low speed has been difficult. But since, by using the drive control device 100 described above, it is possible to implement sine wave driving from the zero speed, accordingly it is possible to implement improvement of the efficiency of an air conditioner (i.e. saving of energy).

### Twelfth Embodiment

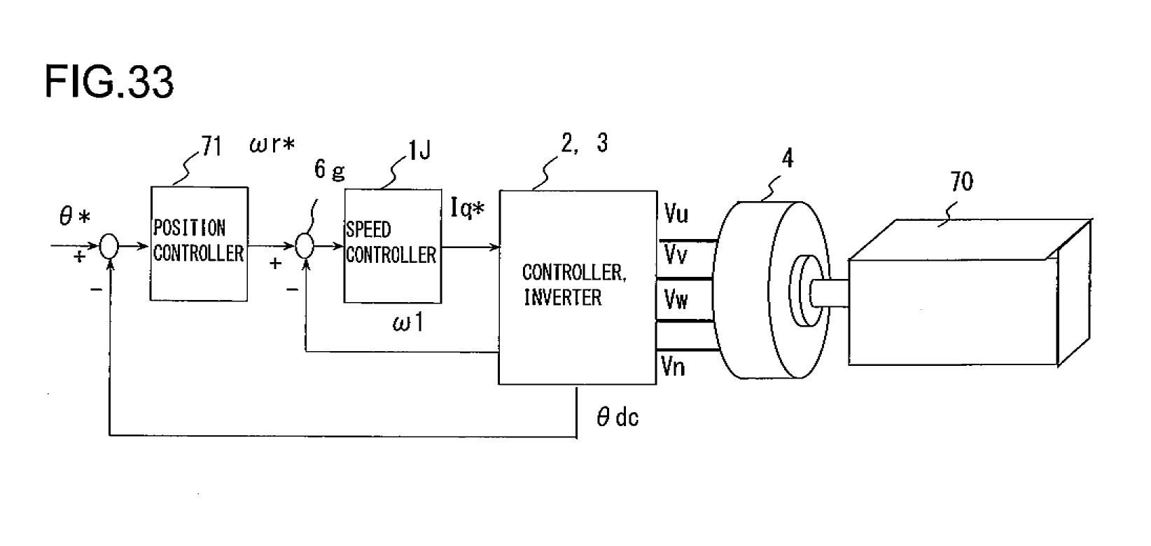

Finally, a twelfth embodiment of the present invention will be explained. This twelfth embodiment relates to a position determination device, in which a position determination stage 70 is driven by the motor 4 that is driven and controlled by the drive control device 100 as described in one of the first through the eighth embodiments. FIG. 33 is a figure showing the overall block structure of this position determination device.

In FIG. 33, an Iq* generator 1J functions as a speed controller. Moreover, a speed command ωr* is supplied as the output of a position controller 71 that is a higher level control block. Comparison with the actual speed ωr is performed by a subtractor 6g, and Iq* is calculated so that the difference between them becomes zero. The position determination stage 70 is a device that employs, for example, a ball screw or the like, and is adjusted by the position controller 71 so that its position is controlled to a predetermined position θ*. No position sensor is attached to the position determination stage 70, but rather the position value as estimated by the controller 2 is employed just as it is. By doing this, it becomes possible to perform position control in which it is not necessary to equip the position determination device with any position sensor.

With this type of position determination device, in a similar manner to the case with an electrically driven steering of an automobile, forward rotation and reverse rotation of the motor 4 are frequently repeated. In such a case, it is necessary to stop the rotation temporarily and then to reverse its direction, and both high readiness and high positional accuracy are demanded during this reversal of forward and backward operation. It is possible to respond sufficiently to those demands by using the drive control device 100 for a three-phase synchronous motor described above. In terms of reversal of forward and backward operation, the same holds in relation to a three-phase synchronous motor that is employed in a washing machine.

As has been explained above, this three-phase synchronous motor drive device comprises: the three-phase inverter 3 that comprises switching elements for each of three phases and that drives the motor 4 that is a three-phase synchronous motor; the controller 2 that functions as a control unit that selects four switched states from a plurality of switched states that represent on/off states of the switching elements for the three phases, and that sequentially controls the three-phase inverter in these four switched states; and the neutral point potential amplifier 13 that functions as a neutral point detection unit that detects the neutral point potential Vn0 of the stator windings (Lu, Lv, and Lw) of the motor 4 in each of the four switched states; and wherein it is arranged to estimate the rotor position of the three-phase synchronous motor over the full range of the electrical angle cycle on the basis of at least three of the four neutral point potentials detected in the four switched states.

For example, in the first embodiment described above, voltage commands that generate the four switched states are outputted from the voltage command generator 17 for initial position estimation and it is possible to estimate the rotor position during starting of rotation over the full range of the electrical angle cycle by performing estimation with the initial position estimator 19 using the four neutral point potentials that are detected at this time. Moreover, even during rotational operation, it is possible to generate four voltage vectors (i.e., switching vectors) like those shown in FIG. 26 by correcting the voltage command Vq*, which is the voltage command for rotational torque, with the Vq corrector 21G. For this, by for example also including a structure like that of the initial position estimator 19, 19B, 19C, or 19D shown in FIG. 9, 11, 13, or 14 in the position estimator 15, and by changing over the number of voltage vectors generated between two and four, it becomes possible to perform estimation of the rotor position over the full range of the entire electrical angle cycle.

Furthermore, since it is possible to obtain the changes of potential that depend upon the rotor position by detecting the neutral point potentials in synchrony with the pulse voltages applied from the inverter to the motor, accordingly position information may be obtained by PWM (pulse width modulation) during normal sine wave modulation. Therefore, it is possible to estimate the rotor position of the three-phase synchronous motor instantaneously in the stopped state, and, from the zero speed, it is possible to drive the motor with sine wave shaped currents.

Moreover, the embodiments described above may be employed either singly or in combination. This is because the advantageous effects of each of the embodiments may be obtained either by itself or in synergistic combination with other embodiments. Furthermore, provided that the essential characteristics of the present invention are preserved, the present invention is not to be considered as being limited by the embodiments described above in any way.

1. A three-phase synchronous motor drive device comprising:
a three-phase inverter that drives a three-phase synchronous motor, and that comprises switching elements for three phases;
a control unit that selects four switched states from a plurality of switched states that represent on/off states of the switching elements for the three phases, and that sequentially controls the three-phase inverter in the four switched states;
a neutral point potential detection unit that detects a neutral point potential of stator windings of the three-phase synchronous motor in each of the four switched states; and
a first rotor position estimation unit that estimates a rotor position of the three-phase synchronous motor over a full range of an electrical angle cycle based on at least three of four neutral point potentials detected in the four switched states;
and wherein four switching vectors that indicate the four switched states comprises a first switching vector and a second switching vector that are mutually oppositely oriented, and a third switching vector and a fourth switching vector that are mutually oppositely oriented.

2. A three-phase synchronous motor drive device according to claim 1, wherein:
the control unit comprises a voltage command output unit that, during starting of rotation of the three-phase synchronous motor, outputs first three-phase voltage commands for initial position estimation that command the four switched states; and
the first rotor position estimation unit estimates the rotor position during the starting of rotation based on the neutral point potentials detected when the first three-phase voltage commands are outputted from the voltage command output unit.

3. A three-phase synchronous motor drive device according to claim 2, wherein:
after output of the first three-phase voltage commands, the voltage command output unit further outputs second three-phase voltage commands based on the rotor position estimated by the first rotor position estimation unit; and
the second three-phase voltage commands are three-phase voltage commands indicating four switched states, such that the four switching vectors comprising two vectors on two sides of a rotor magnetic flux vector in a positive direction and two vectors on two sides of a rotor magnetic flux vector in a negative direction.

4. A three-phase synchronous motor drive device according to claim 2, further comprising:
a first voltage command correction unit that corrects voltage command for rotational torque generated by the control unit, so that third three-phase voltage commands generated based on phase current information for the three-phase synchronous motor become voltage commands that command the four switched states, and moreover become voltage commands that command, as the four switching vectors, vectors that are in a relationship of being close to a rotor magnetic flux vector; and wherein
the control unit controls the three-phase inverter based on the voltage command for rotational torque that has been corrected by the first voltage command correction unit.

5. A three-phase synchronous motor drive device according to claim 2, further comprising:
a second voltage command correction unit that corrects voltage command for rotational torque generated by the control unit, so that third three-phase voltage commands generated based on phase current information for the three-phase synchronous motor become voltage commands that command the four switched states, and moreover become voltage commands that command, as the four switching vectors, vectors that are in a relationship of being close to a vector that is orthogonal to a rotor magnetic flux vector;
and wherein the control unit:
controls the three-phase inverter based on the voltage command for rotational torque that has been corrected by the second voltage command correction unit, when magnitude of the voltage command for rotational torque is smaller than a predetermined value; and
controls the three-phase inverter based on the voltage command for rotational torque that has been corrected by the first voltage command correction unit, when the magnitude of the voltage command for rotational torque is greater than or equal to the predetermined value.

6. A three-phase synchronous motor drive device according to claim 4, further comprising:
a third voltage command correction unit that performs correction so that differences between voltage commands for respective phases in the third three-phase voltage commands become greater than a predetermined difference value.

7. A three-phase synchronous motor drive device according to claim 4, further comprising:
a second rotor position estimation unit that estimates the rotor position of the three-phase synchronous motor based on two neutral point potentials among the four neutral point potentials, or based on an induced voltage induced in the stator windings; and
a rotational speed determination unit that makes a determination as to whether or not a rotational speed of the three-phase synchronous motor is greater than a predetermined rotational speed, based on the rotor position estimated by the first or the second rotor position estimation unit;
and wherein the control unit controls the three-phase inverter according to the four switched states when it is determined that the rotational speed is greater than the predetermined rotational speed, and controls the three-phase inverter according to two among the four switched states when it is determined by the rotational speed determination unit that the rotational speed is smaller than or equal to the predetermined rotational speed.

8. A three-phase synchronous motor drive device according to claim 4, wherein:
the control unit controls the three-phase inverter according to the four switched states when a voltage outputted by the three-phase inverter is less than or equal to a predetermined value, and controls the three-phase inverter according to two among the four switched states when the voltage outputted by the three-phase inverter is greater than the predetermined value.

9. A three-phase synchronous motor drive device according to claim 2, wherein:
the first rotor position estimation unit calculates a sum of the neutral point potentials detected for the first and second switching vectors and a sum of the neutral point potentials detected for the third and fourth switching vectors, and estimates the rotor position of the three-phase synchronous motor based on these two sums that have been calculated.

10. A three-phase synchronous motor drive device according to claim 2, wherein:
the first rotor position estimation unit comprises:
a first position information acquisition unit that obtains a difference between the neutral point potentials for two switching vectors, among the four switching vectors, that are oriented in a same direction, and that acquires first rotor position information based on this difference;
a second position information acquisition unit that calculates a sum of the neutral point potentials detected for the first and second switching vectors and a sum of the neutral point potentials detected for the third and fourth switching vectors, and that acquires second rotor position information based on these two sums that have been calculated; and
a polarity determination unit that determines magnetic flux polarity of the rotor position of the three-phase synchronous motor based on the first and second rotor position information;
and wherein the rotor position of the three-phase synchronous motor is estimated based on a result of determination by the polarity determination unit and the first rotor position information.

11. A three-phase synchronous motor drive device according to claim 2, wherein:
the first rotor position estimation unit comprises:
a first position information acquisition unit that obtains a difference between the neutral point potentials for two switching vectors, among the four switching vectors, that are oriented in a same direction, and that acquires first rotor position information based on this difference; and
a polarity determination unit that acquires the neutral point potentials for one of the two switching vectors and for a switching vector that is oriented oppositely to the one switching vector, and that determines magnetic flux polarity of the rotor position of the three-phase synchronous motor based on a sum of those two neutral point potentials and the first rotor position information;
and wherein the rotor position of the three-phase synchronous motor is estimated based on a result of determination by the polarity determination unit and the first rotor position information.

12. A three-phase synchronous motor drive device according to claim 2, wherein:
the first rotor position estimation unit comprises:
a second position information acquisition unit that calculates a sum of the neutral point potentials detected for the first and second switching vectors and a sum of the neutral point potentials detected for the third and fourth switching vectors, and that acquires second rotor position information based on these two sums that have been calculated;
a third position information acquisition unit that calculates a difference between the neutral point potentials detected for the first and second switching vectors and a difference between the neutral point potentials detected for the third and fourth switching vectors, and that acquires third rotor position information based on these two differences; and
a polarity determination unit that determines magnetic flux polarity of the rotor position of the three-phase synchronous motor based on the second and third rotor position information;
and wherein the rotor position of the three-phase synchronous motor is estimated, over the full range of the electrical angle cycle, based on a result of determination by the polarity determination unit and the third rotor position information.

13. An integrated type three-phase synchronous motor comprising, housed within a common casing, a three-phase synchronous motor drive device according to claim 2, and a rotor and a stator of a three-phase synchronous motor that is driven and controlled by the three-phase synchronous motor drive device.

14. A position determination device, comprising:
a three-phase synchronous motor drive device according to claim 2;
a three-phase synchronous motor that is driven and controlled by the three-phase synchronous motor drive device; and
a position determination stage that is slidingly driven or rotationally driven by forward rotation and reverse rotation of the three-phase synchronous motor.

15. A pump device, comprising:
a three-phase synchronous motor drive device according to claim 2;
a three-phase synchronous motor that is driven and controlled by the three-phase synchronous motor drive device; and
a pump for liquid, that is driven by the three-phase synchronous motor.
